(19) United States
(12) Patent Application Publication
(10) Pub. No.: US 2015/0149228 A1
(43) Pub. Date: May 28, 2015

(54) Personal data lending system and method

(71) Applicants: John Papazian, San Francisco, CA (US); David Harmer, San Francisco, CA (US)

(72) Inventors: John Papazian, San Francisco, CA (US); David Harmer, San Francisco, CA (US)

(73) Assignee: U-SeeMe, Inc., San Francisco, CA (US)

(21) Appl. No.: 13/998,699

(22) Filed: Nov. 25, 2013

(51) Int. Cl. G06Q 10/10

(52) U.S. Cl. CPC G06Q 10/1093
USPC 705/7.18

(57) ABSTRACT

A personal data lending system and method. Data may be generated by a communication device for transmission to another communication device. The data may be contact or scheduling data. The owner can selectively choose to share portions of the data. The data remains in control of the owner even after the data is lent.

A computer program listing appendix is provided on CD-R in this application. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to computer information and communication systems and methods and more specifically to computer information and communication systems and methods for facilitating personal data communication between mobile communication devices.

Users of mobile communication devices often wish to share or exchange scheduling, calendaring or contact information with each other. As an example, a spouse might wish to share calendaring or scheduling information with his or her spouse so that they can coordinate the scheduling of common events.

As another example, a salesperson within a CRM (Customer Relationship Management) team might wish to share customer contact information with another salesperson on the team.

In some instances, a user or sender of such contact information can become ambivalent about sharing contact information because the sender has no control over what recipients can do with the received information once the information is transmitted. In such a case, the sender might simply refrain from sending the contact or scheduling information.

At other times, the sender might wish to share some but not all of the contact or scheduling information. Because existing systems would share the entirety of the contact or scheduling information, the sender again simply refrains from communicating the scheduling or contact information.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a method and system for lending personal data can be found in exemplary embodiments of the present invention.

In a first embodiment, a user employs a mobile communication device to generate and transmit personal data to a recipient. The recipient might also use a mobile communication device to receive the personal data. In one embodiment, the transmitted data might be contact information. In an alternate embodiment, the transmitted data might be calendar information. Further yet, the transmitted data might be both contact and calendar information.

The contact or calendar data is granular as the information is comprised of individually selectable fields of personal data. A user might choose to lend all fields in their entirety or might choose to select one or more fields. Selected fields are lent and displayed; non selected fields are not transmitted.

In this manner, users have flexibility and can control the amount of data lent with data recipients. In other embodiments, the data is lent to data recipients for a temporary duration. In accordance with preferences of the data owner, transmitted data can be revoked after a designated duration or at any time as desired by the data owner.

Consequently, as an example, a CRM salesperson need not be ambivalent about lending customer contact information with another associate, as the salesperson retains control over the lent information. The salesman can revoke lent information, for any reason including, if the recipient of the lent data is no longer part of the sales team.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a data lending communication system according to an exemplary embodiment of the present invention.

FIG. 2 illustrates a block diagram of the Data Lending Application (DLA) of FIG. 1 according to an exemplary embodiment of the present invention.

FIG. 3 is a screenshot of a data access request by the DLA of FIG. 1 according to an exemplary embodiment of the present invention.

FIG. 4 illustrates a screenshot of a contacts interface according to an exemplary embodiment of the present invention.

FIG. 5 illustrates the contact interface of FIG. 4 according to an exemplary embodiment of the present invention.

FIG. 6 illustrates a “Request Sent” dialog box disposed over contacts interface 400 according to an exemplary embodiment of the present invention.

FIG. 7 shows a connection accepted notification message according to an exemplary embodiment of the present invention.

FIG. 8 is a screenshot for an edit contacts interface according to an exemplary embodiment of the present invention.

FIG. 9 illustrates an add field user interface of the contacts interface of FIG. 4 according to an exemplary embodiment of the present invention.

FIG. 10 illustrates a new message interface according to an exemplary embodiment of the present invention.

FIG. 11 illustrates a calendar interface according to an exemplary embodiment of the present invention.

FIG. 12 is a screenshot of a list view calendar interface according to an exemplary embodiment of the present invention.

FIG. 13 illustrates a screenshot of an add event calendar interface according to an exemplary embodiment of the present invention.

FIG. 14 is a screenshot of an add invitee calendar interface according to an exemplary embodiment of the present invention.

FIG. 15 illustrates a screenshot of an availability calendar interface according to an exemplary embodiment of the present invention.

FIG. 16 illustrates a collaboration interface according to an exemplary embodiment of the present invention.

FIG. 17A illustrates John's Black Book interface according to an exemplary embodiment of the present invention.

FIG. 17B illustrates the John's Black Book interface of FIG. 17A according to an exemplary embodiment of the present invention.

FIG. 18A is a screenshot of a shared calendars interface for John's Black Book interface of FIG. 17 according to an exemplary embodiment of the present invention.

FIG. 18B is a screenshot of a shared calendars interface for John's Black Book interface of FIG. 17 according to an exemplary embodiment of the present invention.

FIG. 19 illustrates a screen shot of John's Black Book “Shared With” interface according to an exemplary embodiment of the present invention.

FIG. 20 is a screenshot of a friends interface according to an exemplary embodiment of the present invention.

FIG. 21A shows an add friend interface according to an exemplary embodiment of the present invention.

FIG. 21B shows a new message interface according to an exemplary embodiment of the present invention.

FIGS. 22-1 and 22-2 are flow charts of a method for sharing personal data according to an exemplary embodiment of the present invention.

FIG. 23A shows a typical mobile device such as would be operated by a user.

FIG. 23A shows a typical computer such as would be operated by a user on the Internet.

FIG. 23B shows subsystems of the computer of FIG. 23A.

FIG. 24 illustrates announcements that are lent to friends of black books according to an exemplary embodiment of the present invention.

FIG. 25 is a screenshot of a promotions interface according to an exemplary embodiment of the present invention.

FIG. 26 is a screenshot of a documents interface according to an exemplary embodiment of the present invention.

FIG. 27 illustrates media that are lent to friends of black books.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

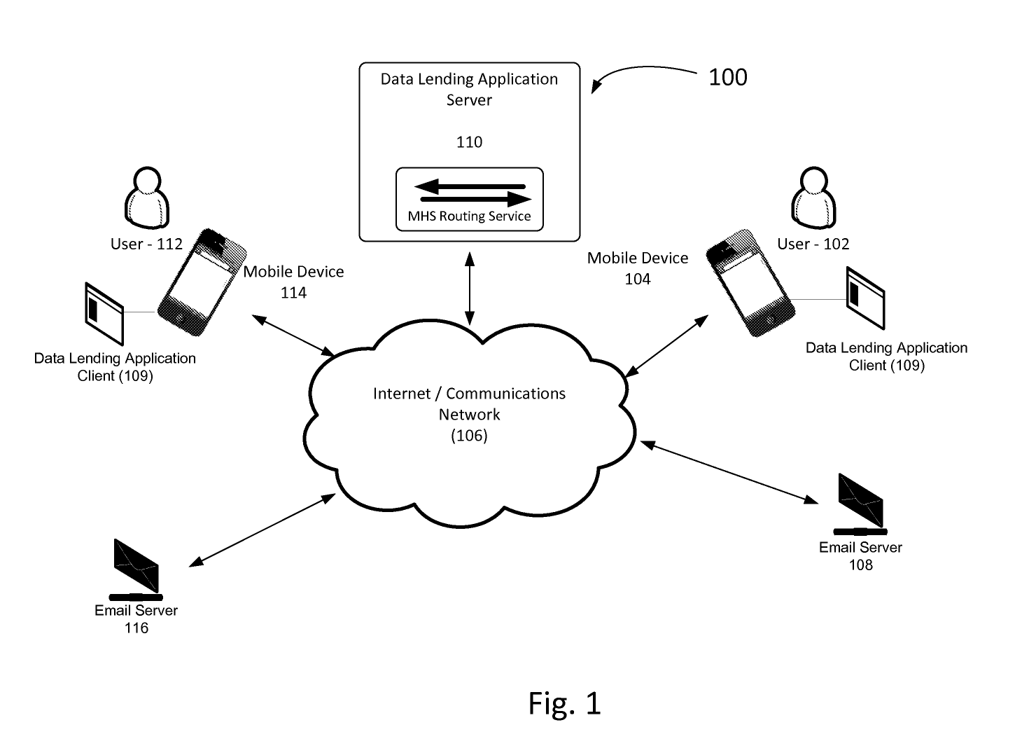

FIG. 1 illustrates data lending communication system 100 according to an exemplary embodiment of the present invention.

In FIG. 1, among other components, data lending communication system 100 comprises user 102 communicably coupled to DLS Server 110 via Internet/communication network 106. Although not shown, Internet/communication network 106 represents any distributed network (wired, wireless or otherwise) for data transmission and receipt between two points. The system of the present invention can work effectively with any possible distribution of interconnected processors regardless of the specific topology, hardware and protocols used.

Here, user 102 represents a person, an entity or the like that wishes to communicate personal data such as scheduling, calendaring, business card or contact data to another person or entity. User 102, for example, may represent a salesperson within a CRM team. As another example, user 102 may represent a spouse wishing to communicate scheduling information.

In fact, user 102 may represent a social network user wishing to communicate personal data to another social network user. Although not illustrated, other user or entity types are contemplated by the present invention so long as such users or entities wish to communicate personal data between mobile communication devices.

In FIG. 1, user 102 employs mobile device 104 for such data communication. Mobile device 104 can be any smart mobile communication device having a memory and a contact list database including an address book, a phone book, calendar or scheduler, the address and phone book sorting phone numbers, emails, personal data and other like information.

Mobile device 104 includes a processor configured to execute software routines of the present application. Mobile device 104 might be an iPhone™ 5 based on the iOS platform. As another example, mobile device 104 may also be based on the Android™ platform. Although not shown, other such future mobile communication devices are also contemplated by those of ordinary skill in the art to be within the confines of the present invention.

Here, Data lending application server 110 might be a combination of processors and/or software capable of communicating with mobile device 104 and from which data lending application 109 can be downloaded by mobile device 104 in accordance with the principles and precepts of the present invention. Data lending application 109 can then be employed by user 102 to communicate and lend personal data to user 112.

Data lending application server 110 may also push user notifications, user information and user analytics. In a preferred embodiment, personal user data including contact and scheduling information resides on user mobile devices. In an alternate embodiment, such personal user data is stored by data lending application server 110.

In FIG. 1, the data recipient, user 112 can be any user or entity that wishes to receive personal data such as scheduling, contact data, business card, etc. from user 102. For example, user 112 might be the spouse of user 102. User 112 may be an associate salesperson of user 102 that wishes to receive (or send) customer contact information from (or to) user 102.

Here, user 112 receives the personal data via his or her mobile device 114. Mobile device 114 can also be a smart mobile communication device having a processor and memory capable of processing and storing data. As an example, mobile device 114 may be a Windows-based device.

In FIG. 1, data lending communication system 100 further comprises a first email server 108 and a second email server 116 respectively communicably coupled to users 102 and 112 via Internet/communication network 106. Here, user 102 maintains an email account on email server 108.

Email server 108 is any computer including processor and email that employs POP (Post Office Protocol) to facilitate email communication between user 102 and user 112. Email server 108 might also employ SMTP (Simple Mail Transfer Protocol) to facilitate such email communication.

Similarly, user 112 maintains an email account on email server 116. Email server 116 might also utilize POP, SMTP or other comparable protocol to facilitate email communication. For example, email server 116 may be based on IMAP (Internet Message Access Protocol).

In operation, user 102, wishing to transfer or communicate personal data to user 112, begins by downloading data lending application 109 from data share application server 110. Data lending application 109 referred to as MHS or MobileHandshake might be accessed via www.mobilehandshake.com. After downloading and installing data lending application 109 on mobile device 104, user 102 then invites user 112 to join a data sharing platform facilitated by data lending application server 110.

User 112 accepts the request and also downloads the data lending application 109 from data lending application server 110. Upon installing the data lending software on mobile device 114, user 102 and user 112 can now communicate personal data via email server 108, via Internet/communication network 106 and email server 116.

An advantage of the present invention, not hereinbefore provided by conventional systems and methods, is that data lending communication system 100 facilitates lending of personal data between user 102 and 112. Owners of personal data maintain ownership of their personal data even though such personal data has been communicated to other users.

Owners can revoke or recall or otherwise exercise jurisdiction over the personal data that was sent. In this manner, owners can confidently send their personal information knowing that they maintain authority over such personal data. Owners can further limit what recipients of such personal data do with such data in accordance with another embodiment of the present invention.

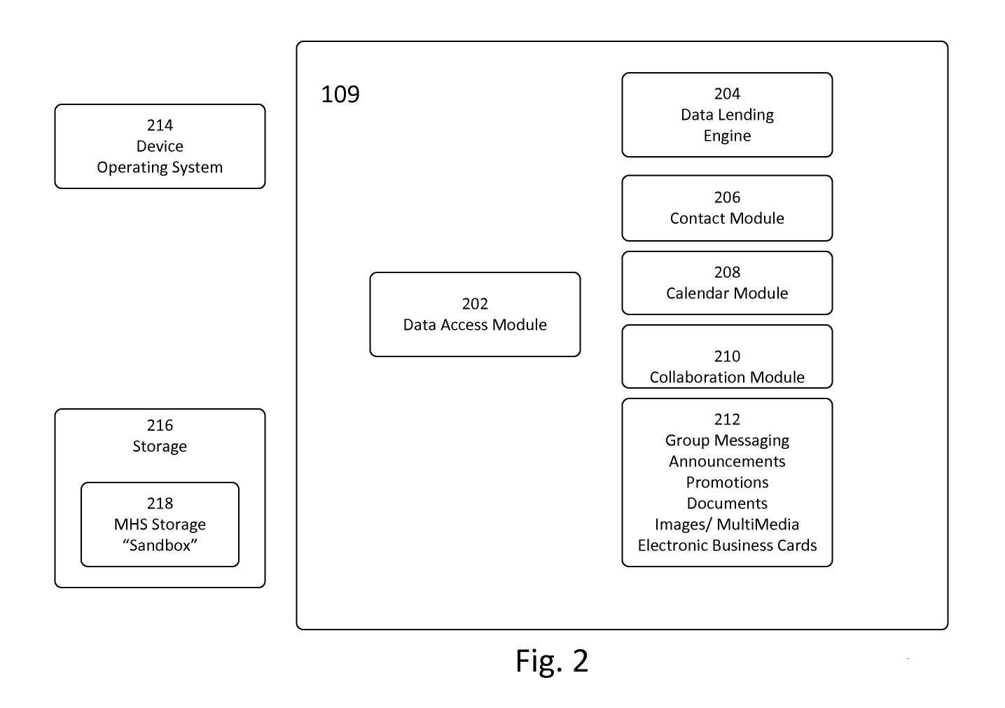

FIG. 2 illustrates a block diagram of data lending application 109 of FIG. 1 according to an exemplary embodiment of the present invention.

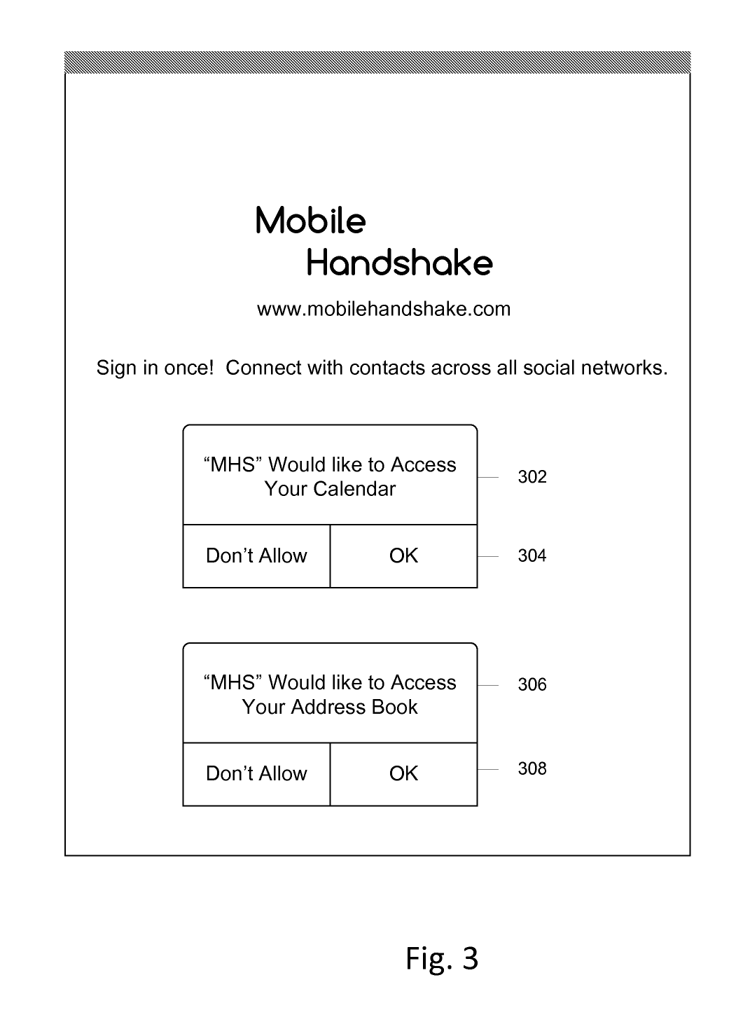

In FIG. 2, data lending application 109 includes data access module 202 that can access stored personal data including contact data, calendar data and collaboration data stored on mobile device 104. Upon user 102 downloading and initiating data lending application 109, a data access request requesting access to personal data stored on mobile device 104 is generated as illustrated FIG. 3.

Referring to now to FIG. 3, FIG. 3 is a screenshot of data access request 300 according to an exemplary embodiment of the present invention.

In FIG. 3, data share application 109 has generated and displayed data access request “MHS would like to access your calendar” 302. Responsive to the data access request, user 102 can select OK button 304 to allow access to calendar and message data.

In FIG. 3, data lend application 109 has generated and displayed data access request “MHS would like to access your address book” 306. Responsive to the data access request, user 102 can select OK button 308 to allow access to calendar and message data.

Referring now to FIG. 2, once user 102 authorizes access, data access module 202 can then access and lend personal contact data in conjunction with contact module 206. In one embodiment, contact module 206 generates a form interface for receiving contact information and then storing said information within storage module 216.

Data access module 202 also cooperates with calendar module 208 to display a calendar interface for entering and receiving calendar data from a user and then storing such data in storage module 216. Furthermore, data access module 202, in conjunction with collaboration module 210, displays a collaboration interface that receives collaboration data and stores such data in storage module 216 as further described with reference to FIGS. 3 through 22 below.

Data access 202 module also cooperates with group messaging/announcements module 212 to provide group messages, announcements, promotions, documents, images, multimedia, and electronic business cards to selected users or friends of user 102. Although not illustrated, it will be understood by one skilled in the art that more or less components may be required to implement data share application 109, and the aforementioned components may be integrated or configured differently from those described above to accomplish the principles and goals of the present invention.

In FIG. 2, data lend engine 202 interfaces with contact module 206, calendar module 208, collaboration module 210 and group messaging/announcements 212 to receive, generate, configure and transmit personal data for sharing and lending to another user such as user 112.

As can be seen in FIG. 2, the entirety of data lending applications 109 interfaces with operating system 214 to run the application, receive and store personal data in storage 216. The stored personal data can be configured for temporary storage on receive mobile device 114 to facilitate lending the personal data to user 112 (FIG. 1).

One way of facilitating lending of data is to “sandbox” the lent data. “Sandbox,” as used herein, is a term used to describe a file system available to each application. Each application has access to a few directories, has read-only access to a special application directory, a read/write access to a documents directory as well as a temp directory.

Applications cannot read from or write to any of the directories, either the system directories or those belonging to other applications. Data lending application 109 can execute instructions to manage the sender's data. The sender's data resides in a secure “sandbox” controlled by the data lending application 109. This data can only be access via the Data Lending Application; MHS. As a result the receiver can use the lent data as if it is their own as long as access/permissions are granted by the sender.

Although not shown, an electronic business card module also operates to generate contact data and transfer such contact data on electronic business cards that can be lent to others. Other users can then forward such electronic business cards to others. In one embodiment, the electronic business cards have three or more dimensions with one dimension having contact information, a second dimension having additional information such business tag lines or objectives and a third dimension having client reference information, for example.

Ownership of such electronic business cards is maintained by the owner. Thus, instances of the electronic cards can be deleted and mass updates can be performed on all child copies of electronic business cards. Other features and functionalities as implemented by data share application 109 of FIG. 1 will now be described.

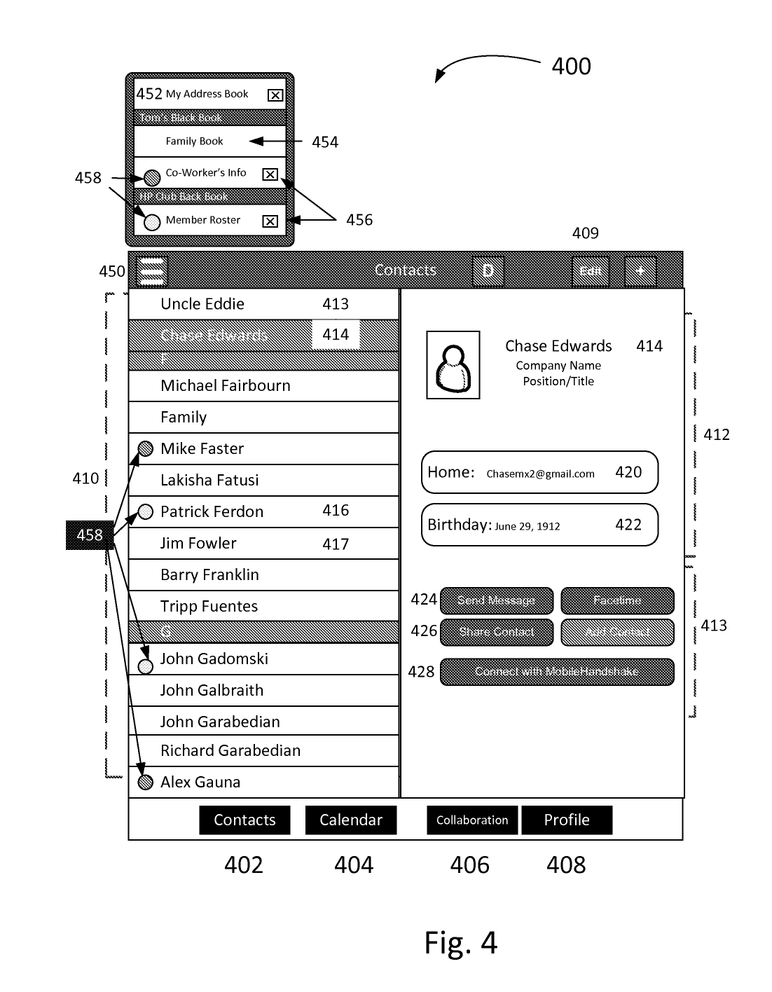

FIG. 4 illustrates a screenshot of contacts interface 400 according to an exemplary embodiment of the present invention.

In FIG. 4, contacts interface 400 generated by contact module 206 (FIG. 2) comprises various interface selection buttons. These interface selection buttons are contacts button 402, calendar button 404, collaboration button 406 and profile button 408.

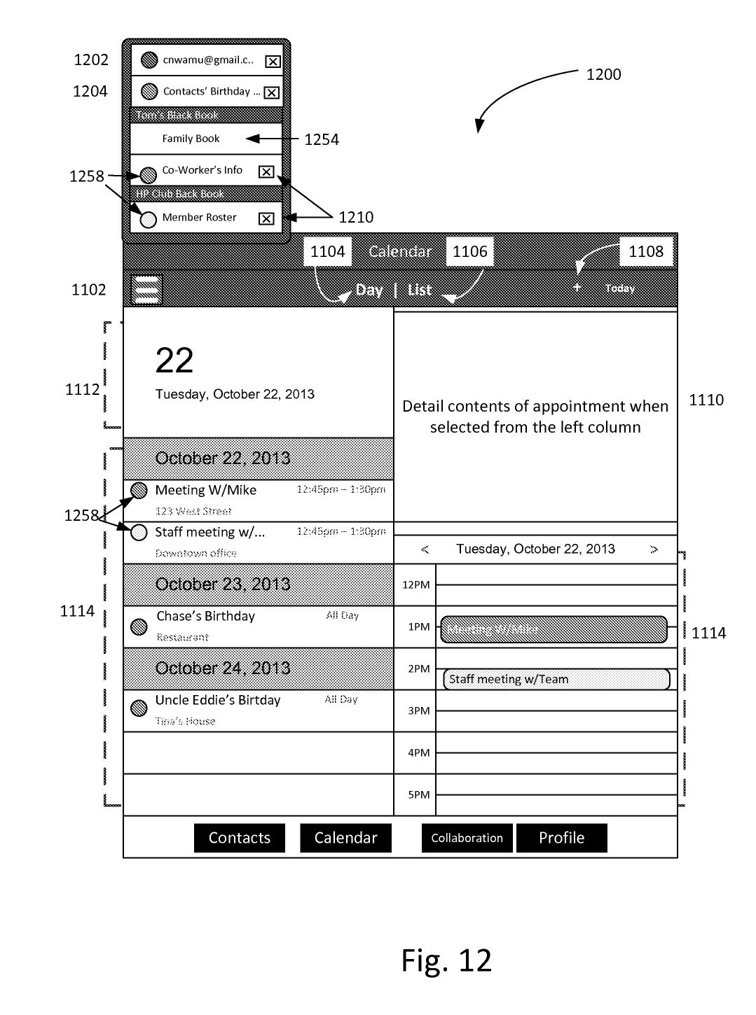

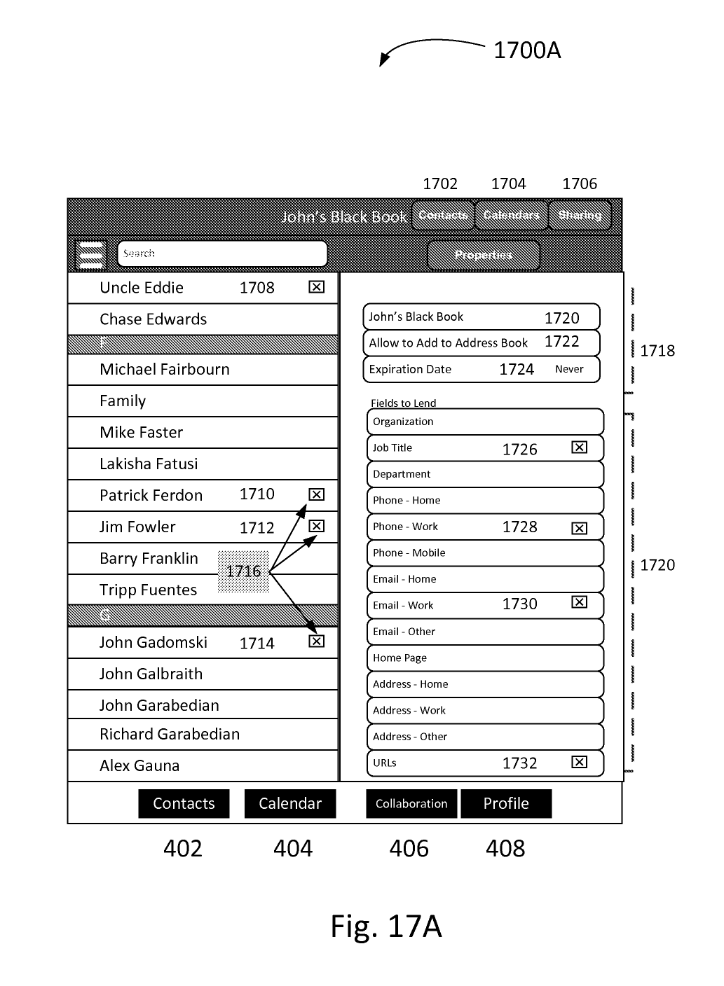

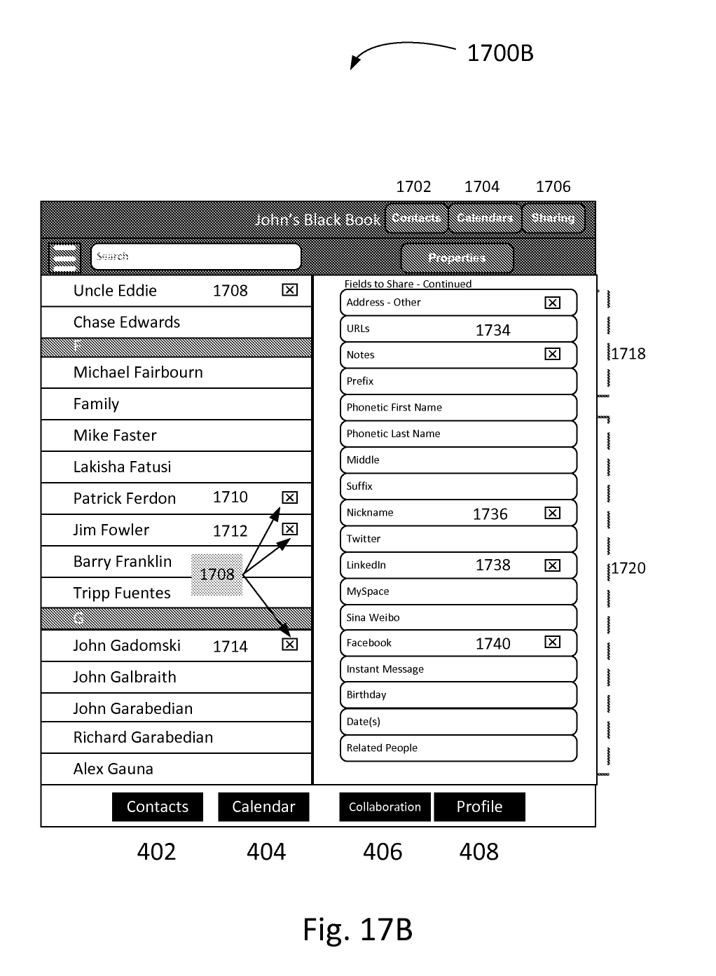

When user 102 selects contacts button 402, the current interface, contacts interface 400 remains and subsequent calendar interfaces described with reference to FIGS. 4-11 are displayed. Selection of calendar button 404 displays calendar interfaces as described with reference to FIGS. 12 through 16; selection of collaboration button 406 displays collaboration interfaces as described with reference to FIGS. 17 through 21, and selection of profile button 408 displays a profile interface that includes personal data for user 102, such personal data being name, address, email address and other such information,

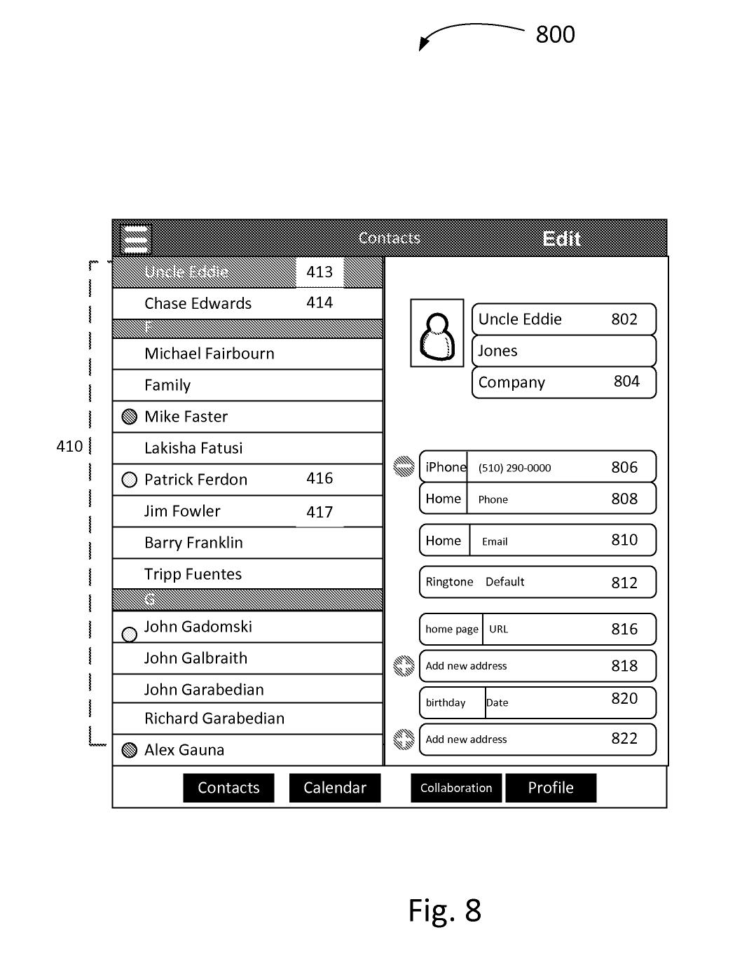

In FIG. 4, contacts interface 400 includes edit button 409 for editing contact information as further discussed with reference to FIG. 8. Proximate to edit button 409, contacts interface 400 also includes contacts list area 410 for displaying a list of stored contacts. For example, contacts list area 410 shows contacts such as “Uncle Eddie” 413, Chase Edwards 414, and Chonda Jordan 416.

Contacts interface 400 also has an individual contact information area 412. Here, information about a single contact highlighted in contacts list area 410 is displayed. Thus, since Chase Edwards 414 is highlighted in contacts list area 410, corresponding information stored for Chase Edwards is displayed in individual contact information area 412. Such corresponding information includes user name Chase Edwards 418, email chasemx2@gmail.com, 420, and birthday “Jun. 29, 2004” 422.

Contacts interface 400 also includes communication buttons area 413 having various communication buttons. Specifically, user 102 may select send message 424 to send text messages to other users. User 102 might also select “Connect with MobileHandshake button 428” to connect with other friends or users via email.

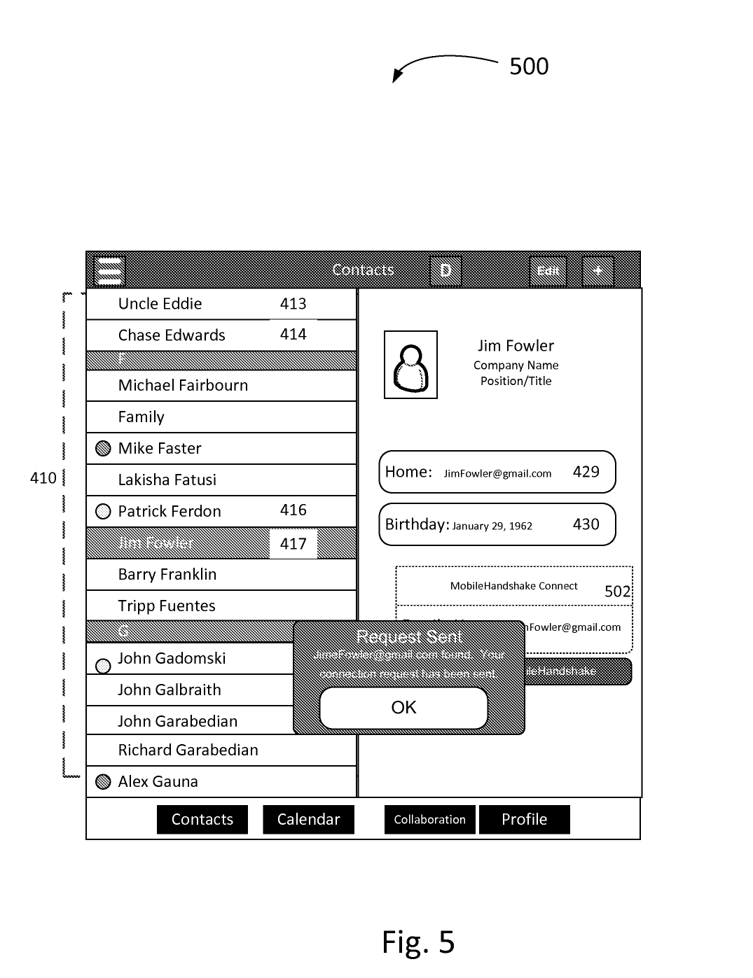

Upon selection of “Connect with MobileHandshake button 428,” a connection request is sent to chasemx2@gmail.com 502 as shown in FIG. 5. User 102 can also utilize share contact button 426 to facilitate sharing of personal data. Once used, the data is no longer under the control of the sender or MHS.

FIG. 5 illustrates contact interface 500, which is an exemplary embodiment of contact interface 400 of FIG. 4.

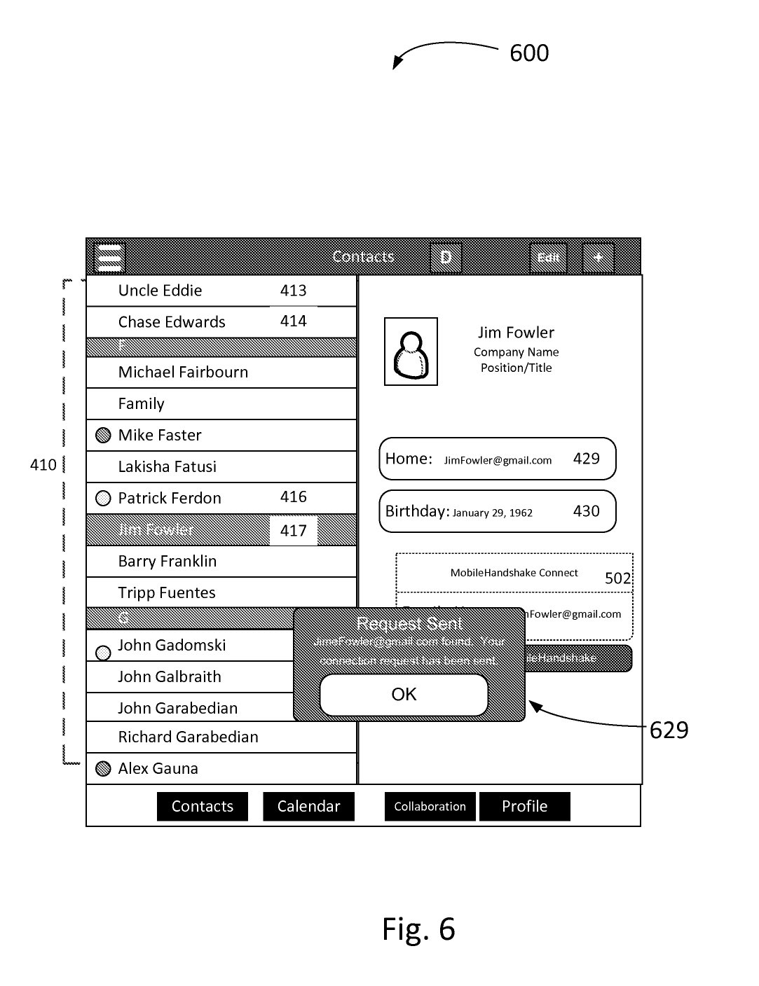

In FIG. 5, contact interface 500 includes email chasemx2@gmail.com, 502, to which the MobileHandshake connect request is sent upon selection of “Connect with MobileHandshake” button 428.” Similarly, as shown in FIG. 6, a connection request has been sent to contact Jim Fowler 417.

FIG. 6 illustrates “Request Sent” dialog box 600 according to an exemplary embodiment of the present invention.

In FIG. 6, request sent dialog box 600 is generated when user 102 wishes to connect with another user and selects “Connect with MobileHandshake” button 428 of FIG. 4. Upon selection of this button, a connection request is sent to the email JimFowler@gmail.com 629 of the currently highlighted contact Jim Fowler 417.

Here, user 102 has sent a connection request to contact Jim Fowler 417 to join the MobileHandshake platform. As seen here, in contacts list area 410, contact Jim Fowler 417 is the currently selected contact and his information is displayed in individual contact information area 412 including her email Jim Fowler@gmail.com 429. Subsequently, “Request Sent” dialog box 600 is displayed confirming that a connection request has been sent to the email address of record.

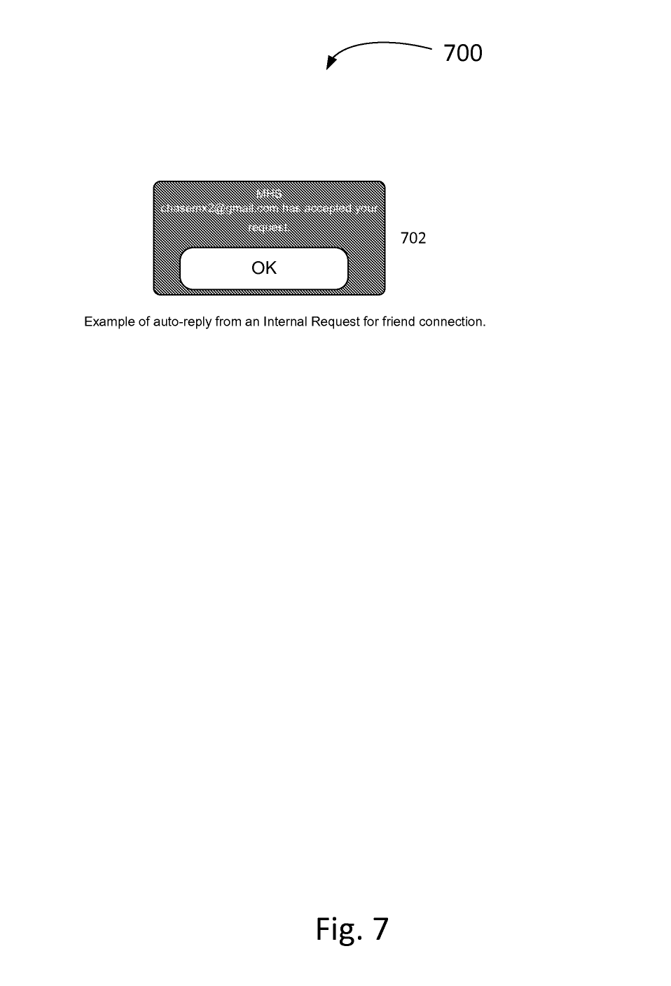

Upon receipt of the connection request by contact Jim Fowler 417, he is given an opportunity to accept the connection request. Once said connection request is accepted, acceptance notification message 702 of FIG. 7 displayed.

FIG. 7 shows notification message 702 according to an exemplary embodiment of the present invention.

In FIG. 7, notification message 702 informs user 102 that “JimFowler@gmail.com has accepted your request.” User 102 and contact Jim Fowler 417 are now connected.

FIG. 8 is a screenshot for edit contacts interface 800 according to an exemplary embodiment of the present invention.

In FIG. 8, user 102 has selected edit button 409 of FIG. 4 in order to edit specific contact information. After all edits, contacts module 206 of FIG. 2 saves and generates an appropriate contact (or calendar) information file.

Specifically, user 102 has selected to edit contact information for Uncle Eddie 413. User 102 can enter or edit name field 802, company field 804, phone field 806, mobile phone field 808, email field 810, ring tone field 812, text tone field 814 and home page URL field 816. User 102 can also use add new address field 818 to add a new address for Uncle Eddie 413. Other fields include birthday field 820 and add field button 822. User 102 may employ add field button 822 for adding additional fields as desired.

All fields of the present invention are selectable for lending. One embodiment, when a field is selected for lending, data for the selected field is saved separately for transmission and sharing with desired users. Data for the non-selected fields are not saved so that such fields will not appear when viewed by the data recipient. Further, for the lent data, they can be updated or deleted as designated by the owner or sender of such data.

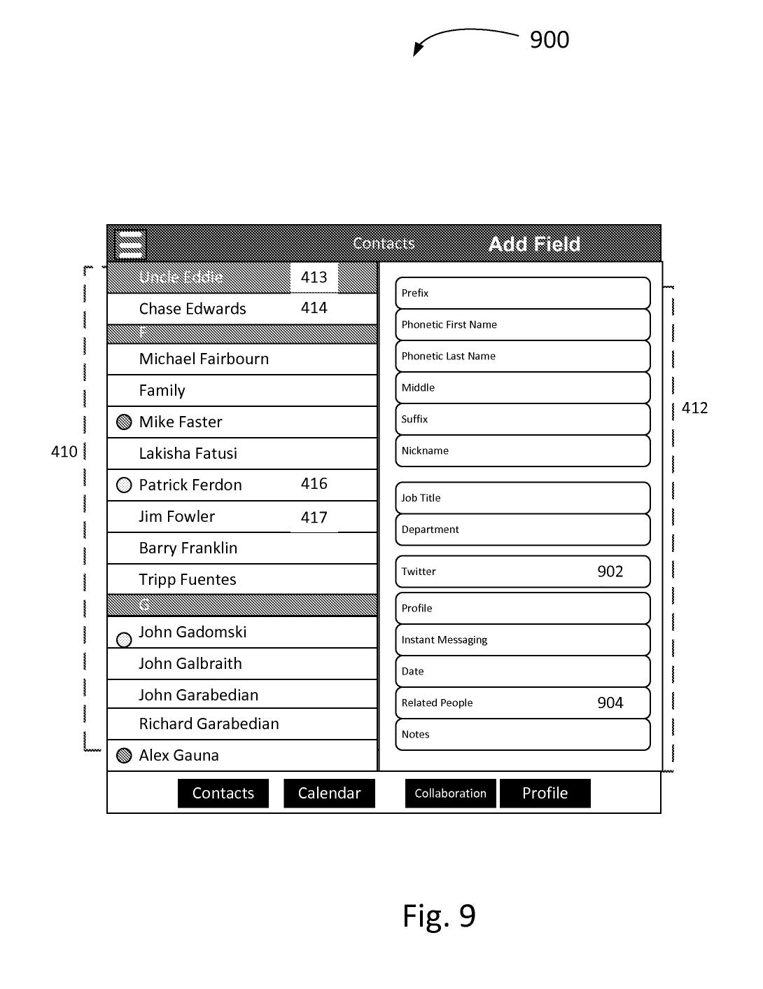

Thus, the present interface maintains flexibility as to numerous types of personal data that can be stored and lent. The present invention provides the ability to add and select numerous fields for lending not hereinbefore disclosed by conventional systems and methods. As an example, when add field button 822 of FIG. 8 is selected, the add field interface 900 of FIG. 9 is displayed.

FIG. 9 illustrates add field user interface 900 according to an exemplary embodiment of the present invention.

In FIG. 9, add field user interface 900 includes individual contact information area 412 that includes numerous fields as shown. One such field might be a Twitter field 902 for including a Twitter handle and a related people field 904 for including people related to the content.

As can be seen, the present invention includes numerous fields, some of which user 102 might wish to remain confidential. The present invention allows selection of any field that is confidential and prevents such fields from being transmitted when a contact profile is sent to another user.

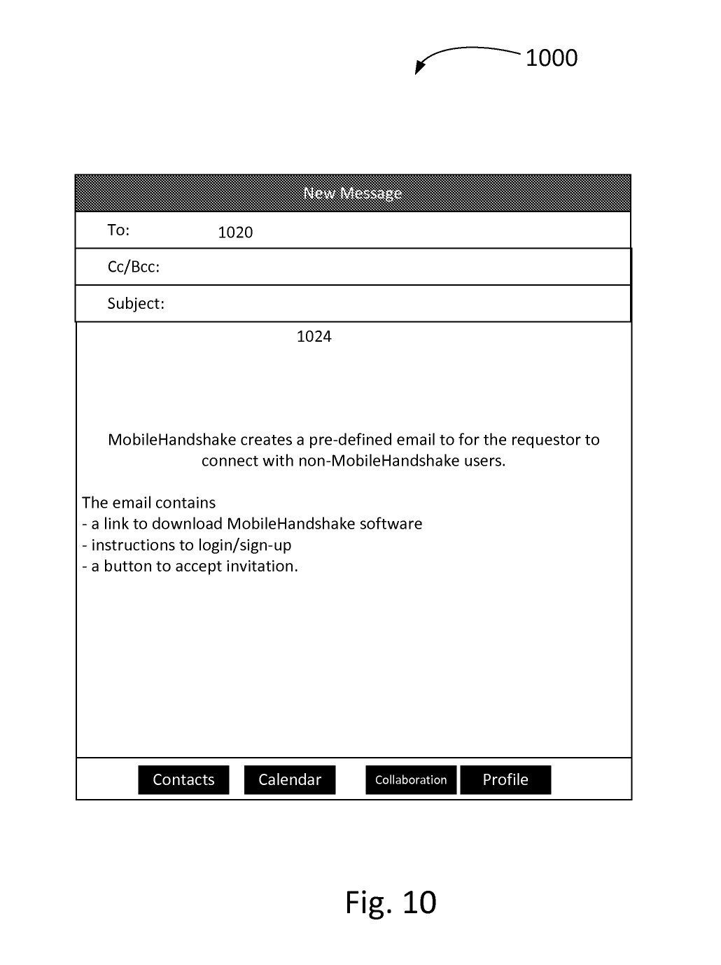

Thus, the present invention is very granular, and fields and sub-fields can be selected for nondisclosure, or alternatively, the entirety of the contact information can be disclosed and transmitted to another user. Referring now to FIG. 4, selection of share contact button 426 displays new message interface 1000 of FIG. 10.

FIG. 10 illustrates new message interface 1000 according to an exemplary embodiment of the present invention.

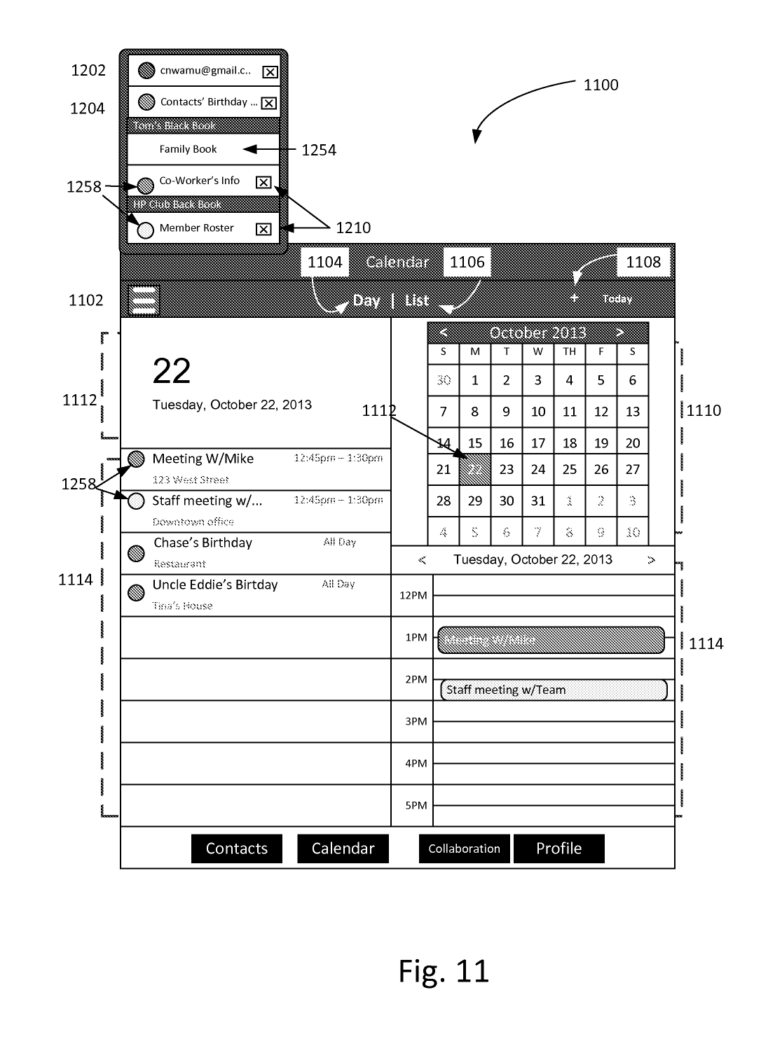

FIG. 11 illustrates calendar interface 1100 according to an exemplary embodiment of the present invention.

In FIG. 11, calendar interface 1100, which is displayed when calendar button 404 of FIG. 4 is selected, can be employed by user 102 for scheduling and entering events. Calendar interface 1100 comprises day button 1104 that displays the day interface of FIG. 11. This interface includes month 1110 and day of the week 1112 highlighted within month 1110. Day of week 1112 is also displayed in one-hour intervals 1114. This allows user 102 to enter calendar event information as desired within one-hour intervals.

FIG. 12 is a screenshot of list view calendar interface 1200 according to an exemplary embodiment of the present invention.

In FIG. 12, specifically, list view calendar interface 1200 is displayed by selecting menu button 1102 (FIG. 11) followed by list button 1106 (FIG. 11). Selecting menu button 1102 displays user information area 1202 having a list of user 102's information organized by specific events. Thus, upon selecting birthdays 1204, a list of birthdays on user 102's calendar is displayed. Thus, as seen, Uncle Eddie Jones' birthday 1206 and Chase Edward's birthday 1208 are displayed on the calendar. Note that check mark 1210 indicates that the selected events are the birthdays 1204, and events for cnwamu@gmail.com are active and are to be displayed on the calendar.

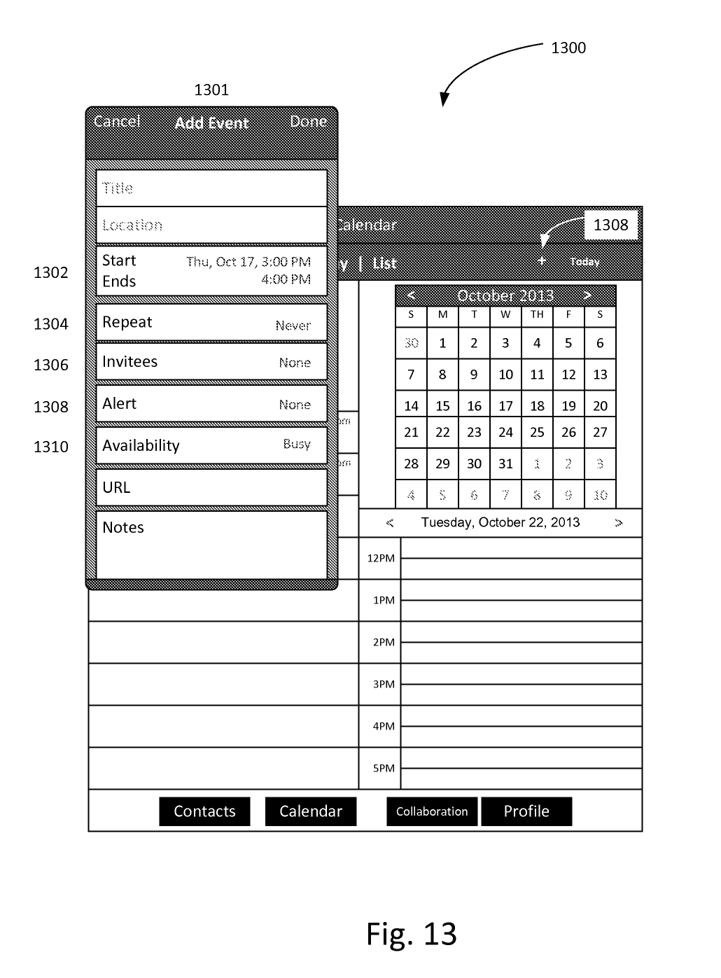

FIG. 13 illustrates a screenshot of add event calendar interface 1300 according to an exemplary embodiment of the present invention.

In FIG. 13, when user 102 selects add button 1308 of FIG. 13, add event form 1301 is generated. User 102 can use add event form 1301 to schedule calendar events. User 102 can enter a start or end time 1302, can choose to repeat the events at 1304, and may choose to invite invitees 1306, generate alerts 1308 and indicate availability at 1310.

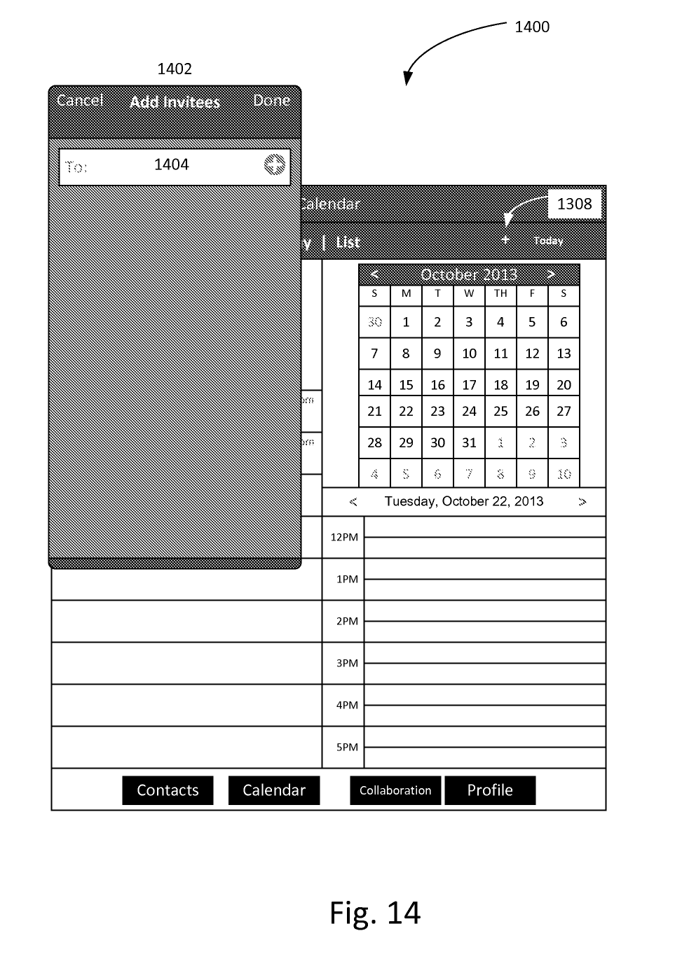

FIG. 14 is a screenshot of add invitee calendar interface 1400 according to an exemplary embodiment of the present invention.

In FIG. 14, add invitee calendar interface 1400 includes add invitee form 1402 for adding invitees. User 102 can use field 1404 to enter an invitee email address or other contact information.

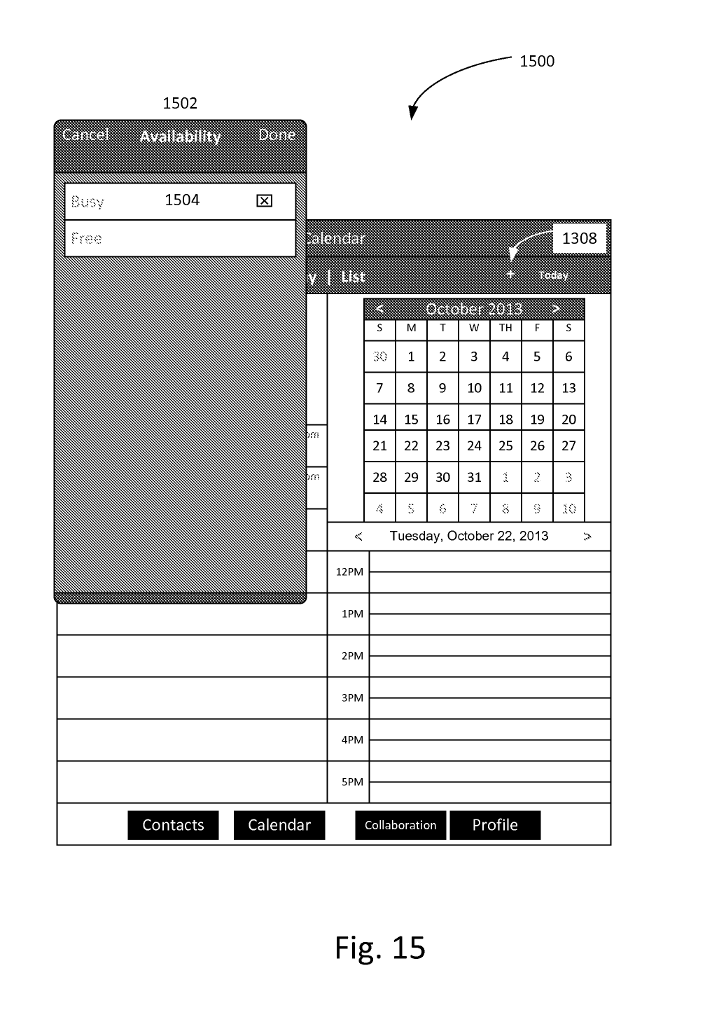

FIG. 15 illustrates a screenshot of availability interface 1500 according to an exemplary embodiment of the present invention.

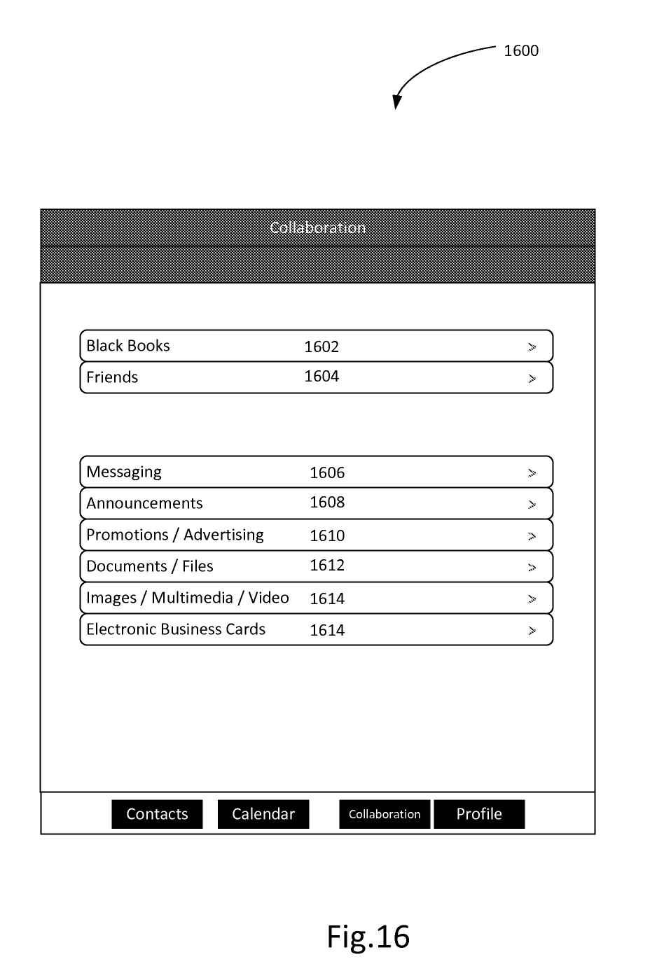

In FIG. 15, availability interface 1500 might include an availability form 1502 that enables user 102 to indicate on the calendar whether a busy or free indication should be assigned to a particular time or event on the calendar. Note that availability form 1502 is generated by selecting availability button 1410 of FIG. 14. Reference will now be made to the collaboration interface menu of FIG. 16.

FIG. 16 illustrates collaboration interface 1600 according to an exemplary embodiment of the present invention.

In FIG. 16, this collaboration interface is generated by selecting collaboration button 406 (FIG. 4). As will be seen, collaboration interface 1600 facilitates generating, storing and lending of personal data to other users such as user 112.

Collaboration interface 1600 includes black books menu 1602 and friends menu 1604, messaging 1606, Announcements 1608, Promotions/Advertising 1610, Documents/Files 1612, Images/Multimedia/Video 1614, Electronic Business Cards 1616. Selection of black books menu 1602 generates John's Black Book interfaces 1700A and 1700B of FIGS. 17A and 17B, respectively.

FIG. 17A illustrates John's Black Book interface 1700A according to an exemplary embodiment of the present invention.

In FIG. 17A, John's Black Book interface 1700A facilitates creation and management of the sharing of information. This lending, creation and management of information is facilitated by connecting with at least one friend as described below and then selecting one or more contacts to be shared with one or more friends.

Here, John's Black Book interface includes contacts button 1702, calendars button 1704 and sharing button 1706. User 102 can select contacts button 1702 to display the current interface for sharing personal data as well as appropriate fields of those contacts that are to be shared.

Here, user 102 has selected contacts Uncle Eddie Jones 1708, Patrick Ferdon 1710, Jim Fowler 1712 and John Gadomski 1714 as contacts to be lent. Check marks 1716 indicate that the selected contacts were indeed selected.

John's Black Book interface 1700A further comprises settings area 1718 as well as fields to lend 1720. User 102 may allow users to add to an address book that was received by selecting allow add to address book 1722 as well as select an expiration date for the address book at 1724.

In the fields to lend area 1720, user 102 can select desired fields to share with other users. Here, user 102 has selected the following fields: job title 1726, work phone 1728, home email 1730 and URLs 1732.

FIG. 17B illustrates John's Black Book interface 1700B according to an exemplary embodiment of the present invention.

In FIG. 17B, user 102 has also selected notes 1734, nickname 1736, LinkedIn 1738 and MySpace 1740. Thus, the present invention enables user 102 to select specific fields of an address book that the user wishes to share with designated friends.

User 102 can select multiple contacts for inclusion in the address book and select specific fields of those multiple contacts for distribution to one or more friends selected as desired by the user. After selecting contacts and specific fields for sharing, user 102 can then select calendar 1704 of FIGS. 17A and 17B in order to select calendars for sharing.

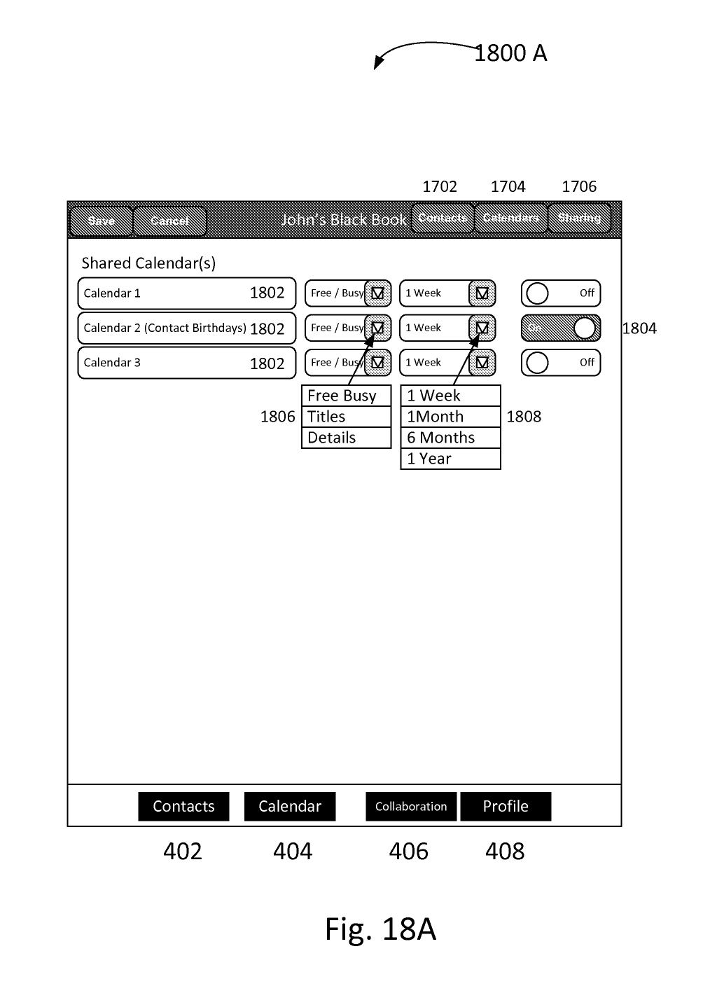

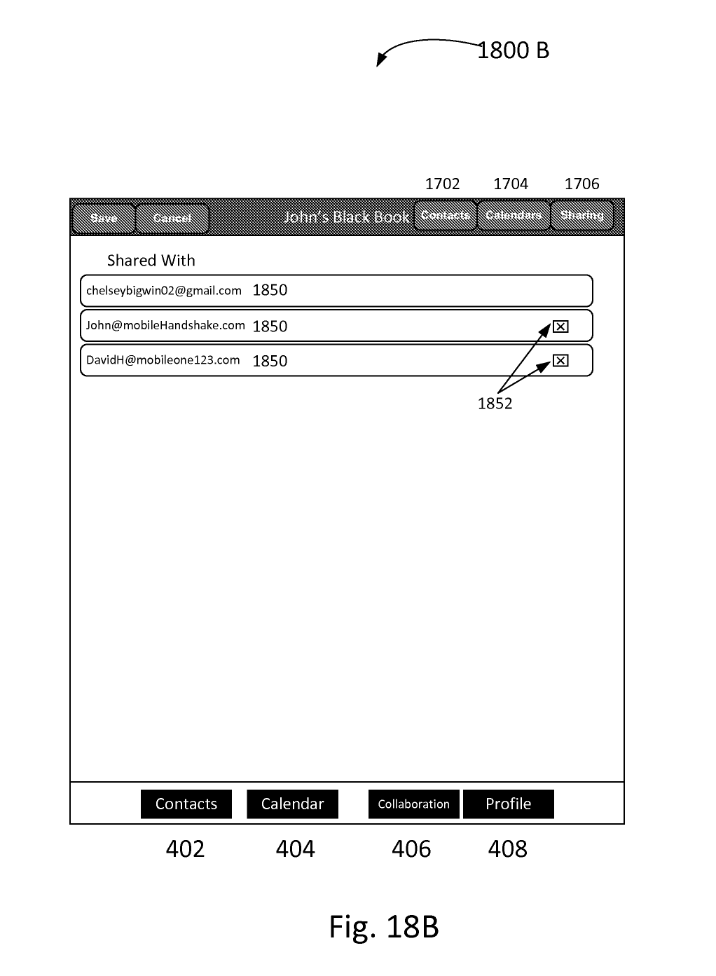

FIG. 18A is a screenshot of shared calendars interface 1800A according to an exemplary embodiment of the present invention.

In FIG. 18A, displays the options for selection and permissions for lending calendars. Item 1802 is the local calendars available to user 102. This list can vary user to user based on their local setup. Button 1804 toggles whether to lend the calendar or not. When 1804 is select to on, then the remaining options activate. Selection 1806 sets the level of detail that the calendar will lend. There are three levels—Free/busy, titles only, and full detail. Free/busy will transmit only the status of user 102's calendar information. In this case, user 112 will only be able to see if User 102 is busy or available on their calendar. Titles only level transmits the title of the appointment only. In this case, user 112 is able to see the free/busy schedule of user 102 and the title of the events User 102 is participating in. Full Detail transmits the full level of detail of an event. In this case, user 112 can see the above two options as well as the detail of the appointments.

Dropdown 1808 indicates how far into the future the information can be lent. 1 Week, 1 Month, 6 Months, & 1 Year are examples of future time limits. This time window is considered rolling. For example, if User 1 sets Birthdays to 1 month, on November it will transmit 30 days. When the user launches the program on November 2nd, the data lending application will transmit 30 days starting November 2.

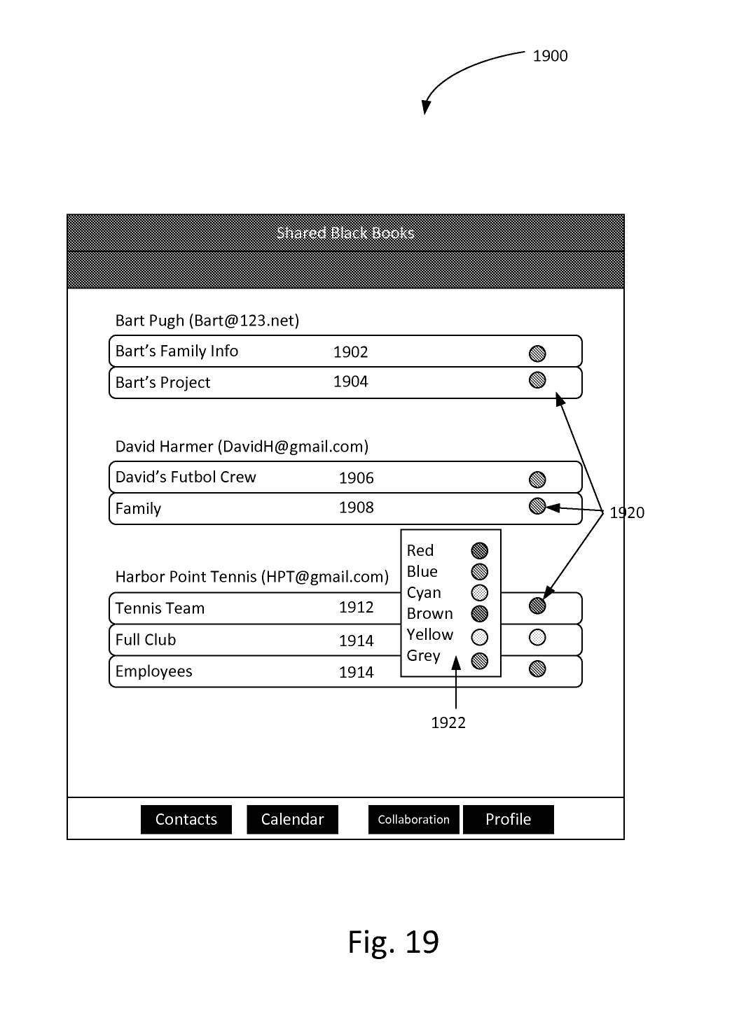

FIG. 19 illustrates a screen shot of the Black Book “Shared with John” interface 1900 according to an exemplary embodiment of the present invention.

FIG. 19, groups the lent Black Books by Owner. Bart Pugh owns Bart's Family Info 1902 & Bart's projects 1904. To help the recipient with managing and identifying the Book, a color coding & icon scheme is added (1920). A popup is used to select the colors 1922. These colors & icons show up on FIGS. 4-458 & FIG. 12 1258. They are also part of the filter selection popup FIG. 4—454 & FIG. 12—1254.

FIG. 4 & FIG. 12 illustrate a screen shot of the Black Book “Shared with John” interface of identifying lent data according to an exemplary embodiment of the present invention.

FIG. 4 screenshot illustrates how a user can select and filter content lent to them from other users. Popup Menu 454 displays user 112's information known as “My Address Book” and also displays lent contact data; the remaining rows below. User 112 can select to include lent data by tapping the row of the popup, for example, “Member Roster” A check mark is displayed 456 to signify that the filter is turned on and the data is visible. Select the row again and the check mark disappears and the data is hidden.

To help the recipient with managing and identifying the Book, a color coding & icon scheme is added (1920). A popup is used to select the colors 1922. These colors & icons show up on FIGS. 4-458 & FIG. 12 1258. They are also part of the filter selection popup FIG. 4—454 & FIG. 12—1254.

FIG. 4 & FIG. 12 illustrates a screen shot of the Black Book “Shared With John” interface of identifying lent data according to an exemplary embodiment of the present invention.

FIG. 4 screenshot illustrates how a user can select and filter content lent to them from other users. Popup Menu 454 displays user 112's information known as “My Address Book” and also displays lent contact data; the remaining rows below. User 112 can select to include lent data by tapping the row of the popup, for example, “Member Roster” A check mark is displayed 456 to signify that the filter is turned on and the data is visible. Select the row again and the check mark disappears and the data is hidden.

FIG. 12 screenshot illustrates how a user can select and filter content lent to them from other users. Popup Menu 1254 displays user 112's information known as “My Address Book” and also displays lent contact data; the remaining rows below. User 112 can select to include lent data by tapping the row of the popup, for example, “Member Roster” A check mark is displayed 1256 to signify that the filter is turned on and the data is visible. Select the row again and the check mark disappears and the data is hidden.

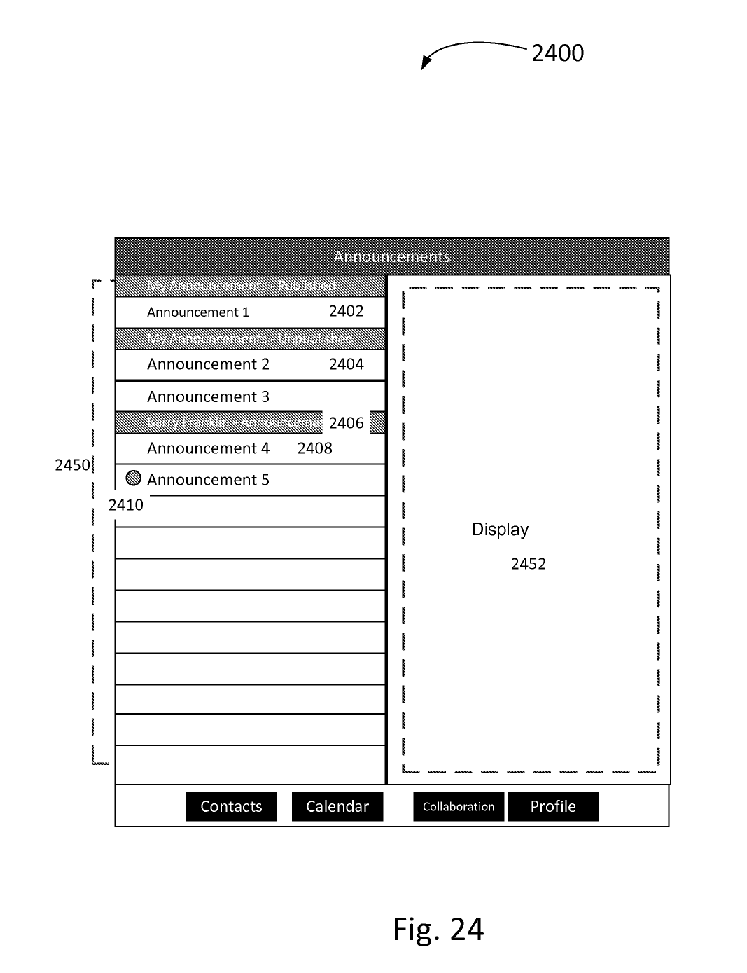

FIG. 24 is a screenshot of announcements interface 2400 according to an exemplary embodiment of the present invention.

FIG. 24 illustrates announcements that are lent to friends of black books. There are 2 sections to the Announcements. Section 1—2450 lists the announcements. That list is made up of My Announcements (published 2402 and unpublished 2404) and Announcements sent to me by friends. The second section—2452 is the preview mode of the announcement that is selected. Blue Button 2410 illustrates that an announcement lent has not been read by user. No button signifies announcement has been read.

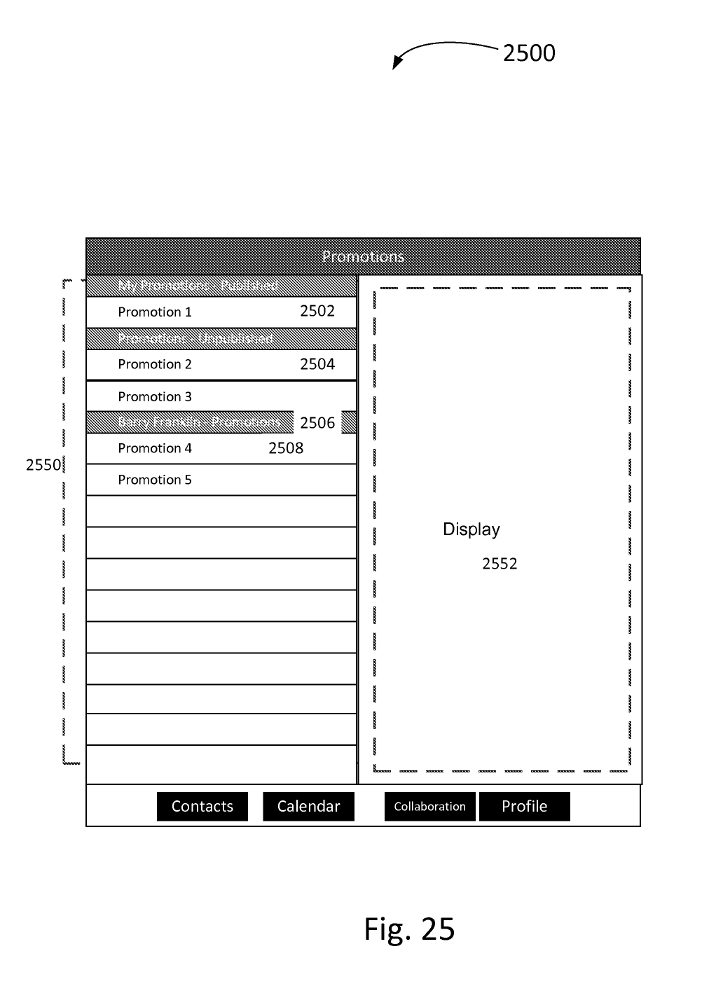

FIG. 25 is a screenshot of promotions interface 2500 according to an exemplary embodiment of the present invention.

FIG. 25 illustrates promotions that are lent to friends of black books. There are 2 sections to the Promotions. Section 1—2550 lists the promotions. That list is made up of My Announcements (published 2502 and unpublished 2504) and Announcements sent to me by friends. The second section—2552 is the preview mode of the promotions that is selected.

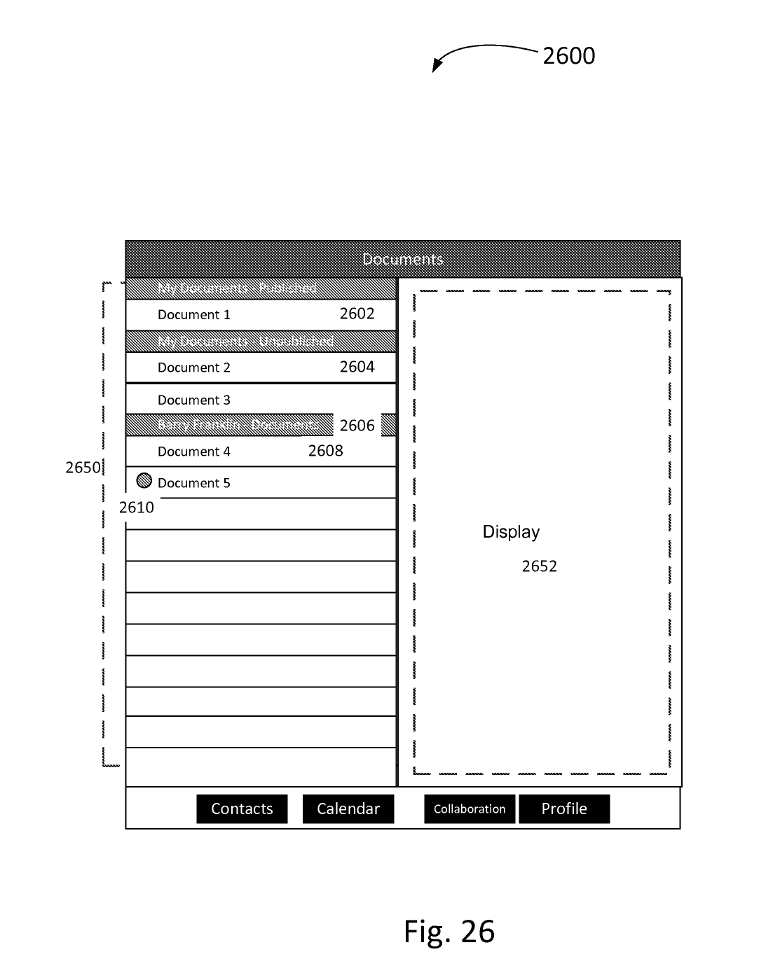

FIG. 26 is a screenshot of documents interface 2600 according to an exemplary embodiment of the present invention.

FIG. 26 illustrates documents that are lent to friends of black books. There are 2 sections to the Promotions. Section 1—2650 lists the documents. That list is made up of My Documents (published 2602 and unpublished 2604) and documents sent to me by friends. The second section—2652 is the preview mode of the documents that is selected. Blue Button 2610 illustrates that documents lent have not been read by user. No button signifies announcement has been read.

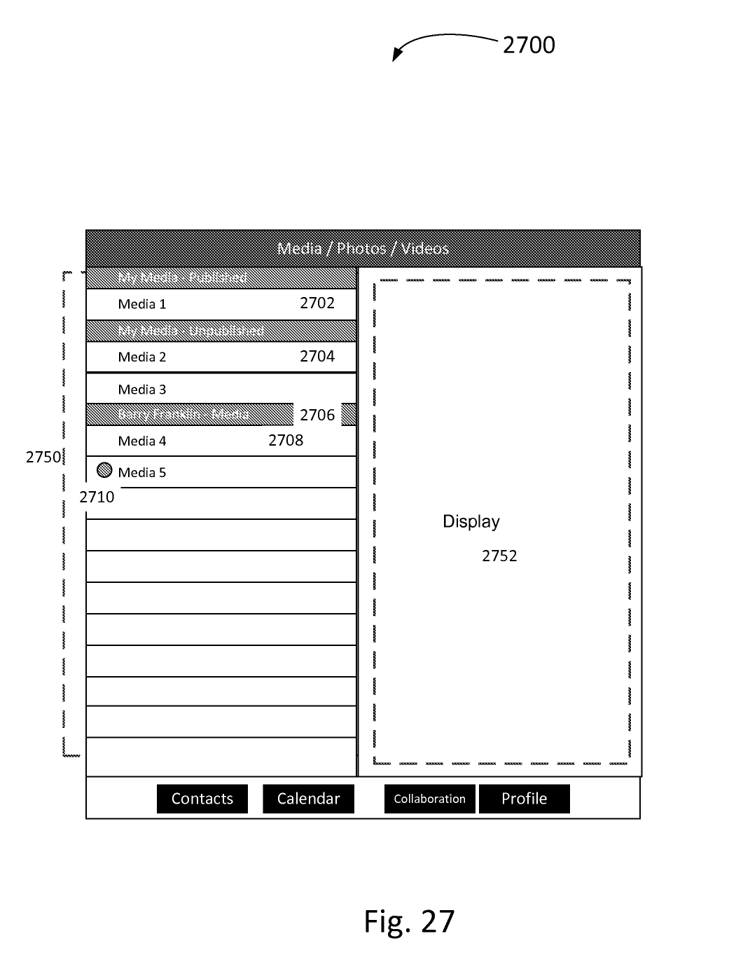

FIG. 27 illustrates media that are lent to friends of black books. Media includes audio, video, photos, and other technologies accepted as multimedia. There are two sections to the media. Section 1—2750 lists the Media. That list is made up of My Media (published 2702 and unpublished 2704) and Media sent to me by friends. The second section—2652 is the preview mode of the Media that is selected. Blue Button 2710 illustrates that media lent has not been read by user. No button signifies announcement has been read.

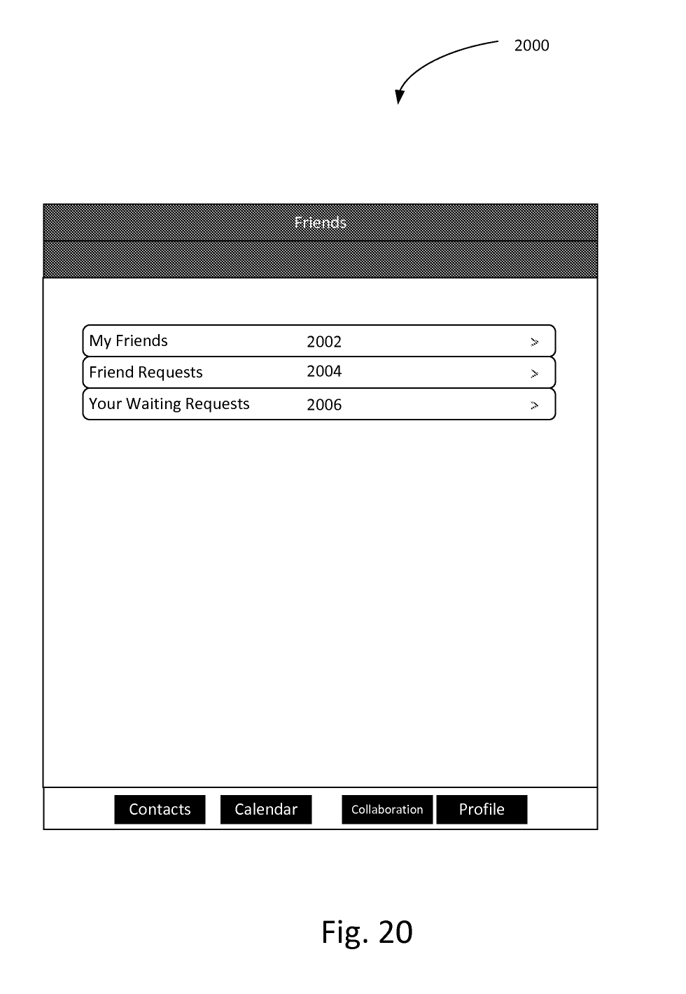

FIG. 20 is a screenshot of friends interface 2000 according to an exemplary embodiment of the present invention.

In FIG. 20, friends interface 2000 is displayed by selecting friends 1604 of collaboration interface 1600 of FIG. 16. As shown, there are three status of friends connections; My Friends, Friend Requests, Your Waiting Requests. Tapping on My Friends 2002 will display active friends list. Tapping Friend Request 2004 will display the list of requests received from other users.

Tapping Your Waiting Requests 2006 will display all pending request by this user. User 102 can delete active connection by swiping left or right on the specific active friend.

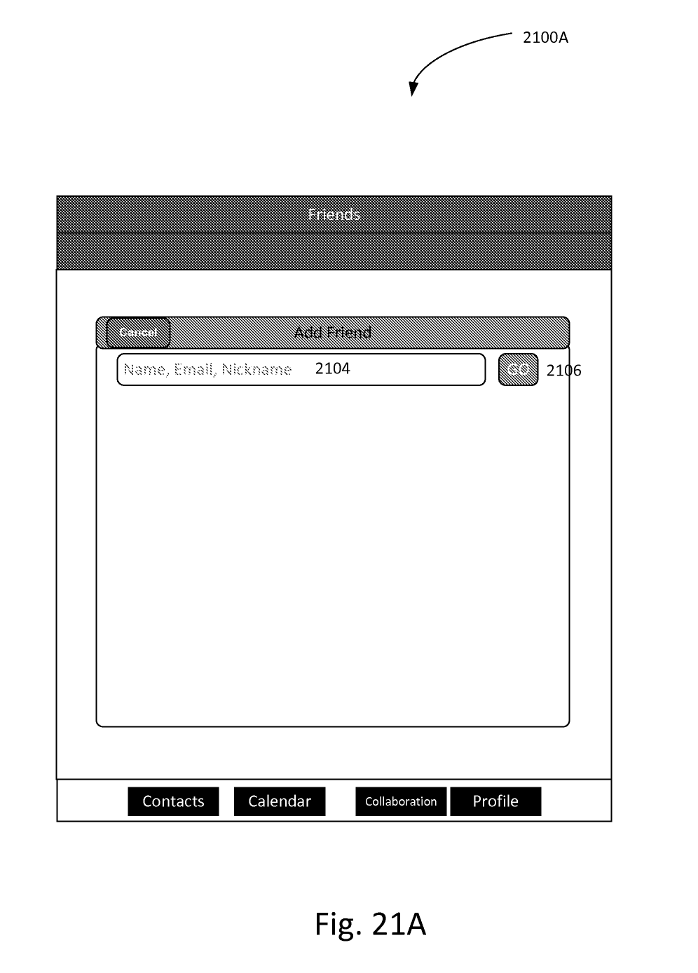

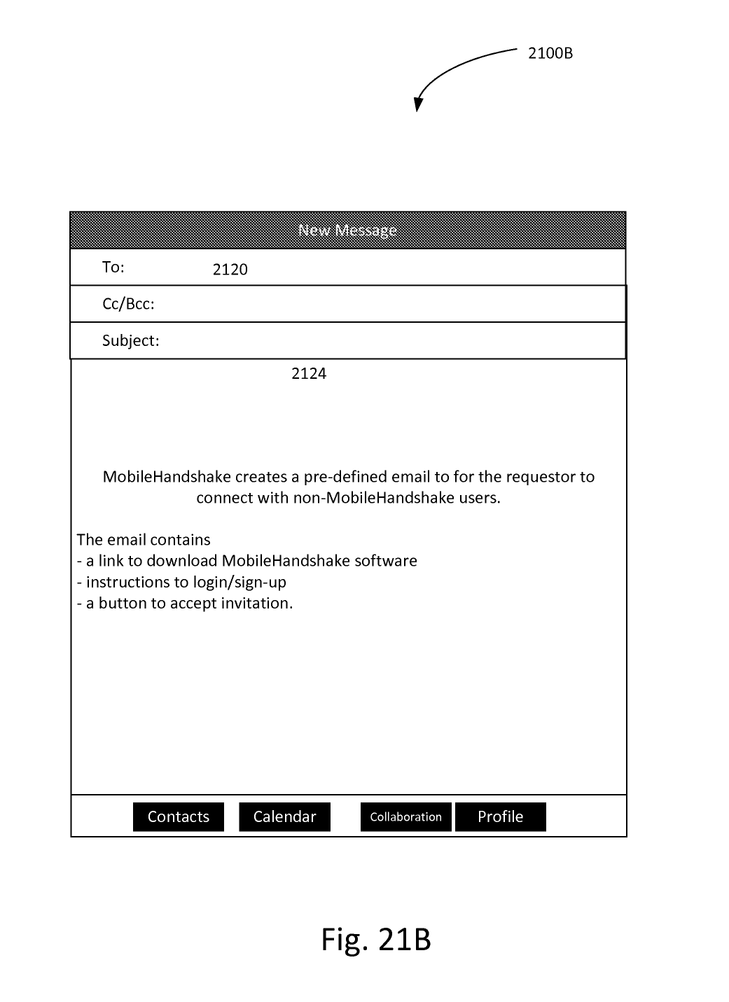

FIG. 21 shows an add friend interface 2100 according to an exemplary embodiment of the present invention.

In FIG. 21, add friend interface 2100 comprises an add friend form 2102 that permits user 102 to enter an email name or nickname in a field 2104 after which the user can select a button 2106 to generate a friend request.

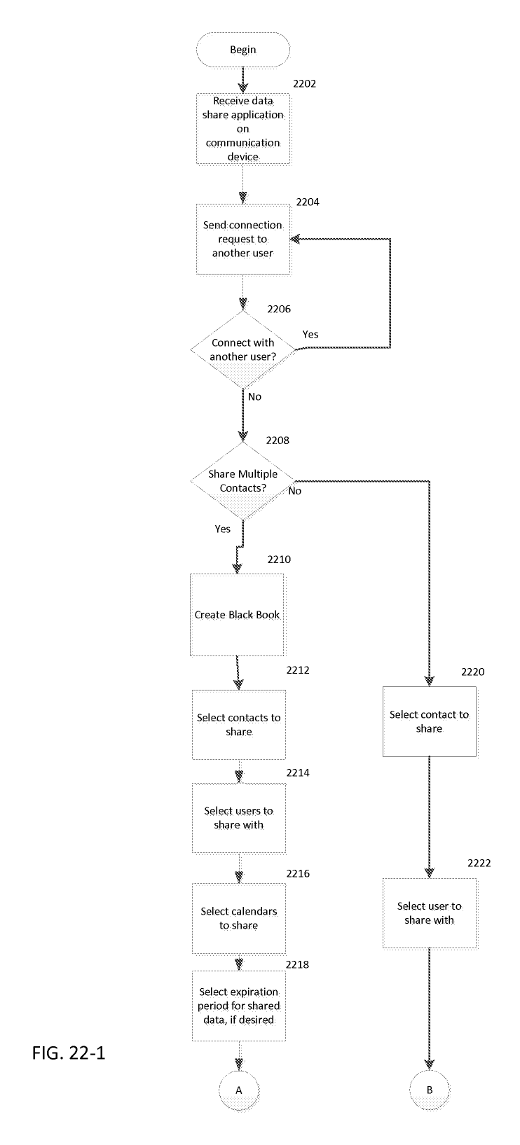

FIG. 22 illustrates method 2200 for lending personal data according to an exemplary embodiment of the present invention.

In FIG. 22, at block 2202, method 2220 begins when user 102 (FIG. 1) downloads data lending application 109 (FIG. 1) onto mobile device 104 (FIG. 1). Mobile device 104 includes a processor and memory for executing data share application 109 and other such software routines.

At block 2204, user 102 sends a connection request message to user 112 (FIG. 1). User 112 accepts the request and downloads the data share application 109 (from data share application server 110). Upon installing the data sharing software on mobile device 114, user 102 and user 112 can now communicate and lend personal data via email server 110, via Internet/communication network 106 and email server 116.

At decision block 2204, if user 102 wishes to connect with another user, then method 2200 returns to block 2204, where user 102 can connect to another user. An advantage of the present invention is that user 102 can connect with as many friends and users as desired irrespective of the social network on which such friends are on. If user 102 does not wish to connect with another user, the method proceeds to decision block 2208.

At decision block 2208, user 102 determines whether contact information for multiple contacts is to be shared. By allowing multiple contacts to be selected, method 2200 enables information for such multiple contacts to be share with a single click or other appropriate user signal. If multiple contacts are to be selected, the method proceeds to block 2210.

At block 2210, a black book is created or edited. Each black book facilitates transmission of multiple contact information and contains selected contacts, calendar and scheduling information to be shared with others.

At block 2212, user 102 selects contacts to be lent from a primary address book. The primary address book is one that is exists prior to creation of the black book. The selected contacts for lending are then saved in the black book.

At block 2214, user 102 then selects users/data recipients with whom the selected contact information is to be lent. User 102 may select one or more users as desired so long as a connection exists between user 102 and the data recipient.

At block 2216, user 102 selects one or more fields of the selected contact information to lend. As an example, user 102 may select only the name field and the work phone number field for lending and may choose not to select home phone number field, which a contact may consider private. In one embodiment, fields may be selected by setting appropriate flags for those fields.

The selected fields are displayed to data recipients, while the non-selected fields are, in one embodiment, displayed as blanks even though such fields contain the requisite contact information. Here, user 102 can also select one or more calendars to lend. The selected calendars are also stored in the black book.

At block 2218, user 102 may set an expiration date or time period after which the shared data expires. Thus, user 102 as owner of the data can determine the duration to lend data to users, friends and other data recipients. The lent data can also be set to prevent a recipient from forwarding or adding data to the data after the lent data is received by a data recipient.

At block 2224, method 2200 involves sharing the contact and/or scheduling information by communicating said information from mobile device 104 to all of the selected data recipients such as user 112 via mobile device 114. The receiving mobile device(s) then store, for a temporary duration, the shared data in a corresponding address book for use by a user of the receiving mobile device.

At decision block 2226, it is determined whether the expiration period for retaining the lent data on the receiving mobile device has elapsed or whether user 102 wishes to revoke the lent data.

At block 2228, the lent data is automatically deleted if the set expiration period has expired. Here, user 102 may also use mobile device 104 to send a signal for revoking the lent data. Method 2200 then proceeds to the end block.

Referring now to block 2220, if user 102 simply wishes to lend a contact, user 102 can proceed to the contact page for contact to be lent, at block 2222, select the user to lend the contact with and then send the contact and/or scheduling information at block 2224.

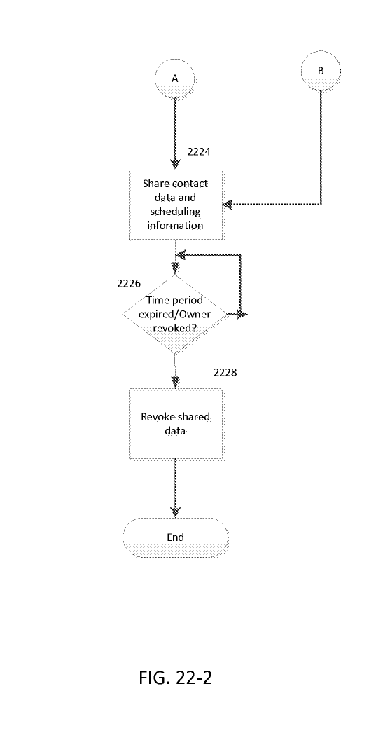

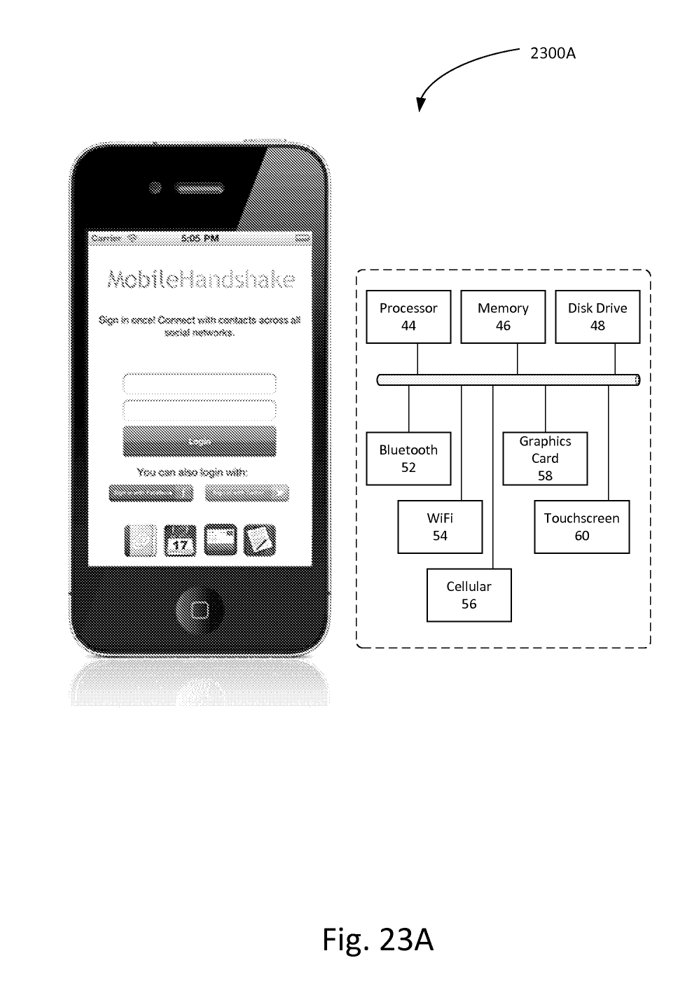

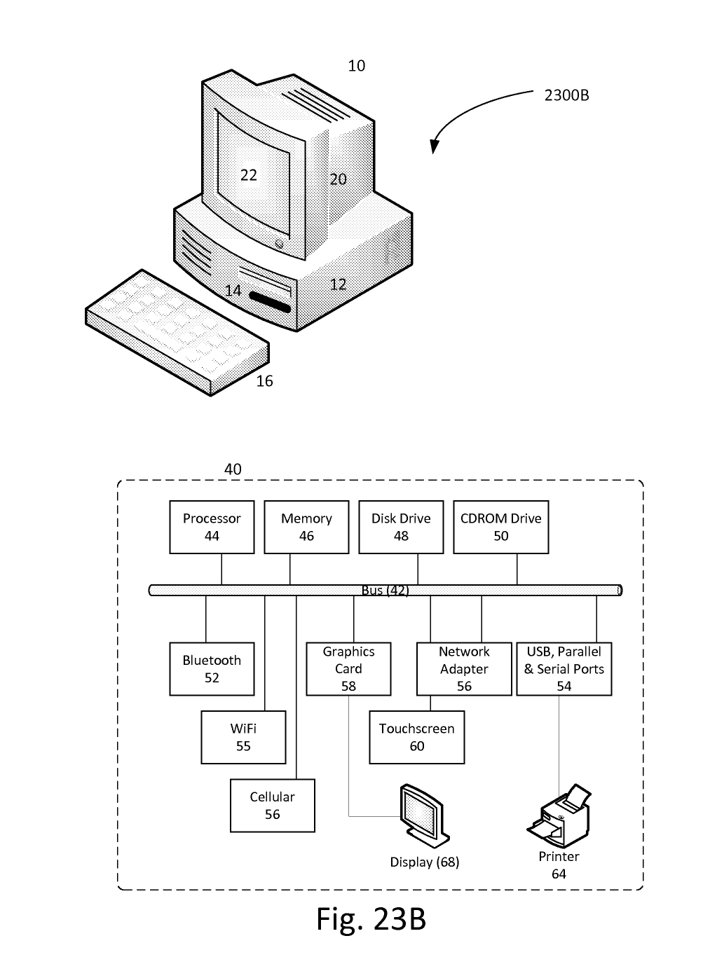

FIG. 23B shows a typical computer 10 such as would be operated by a user on the Internet. Computer 10 includes a cabinet 12 housing familiar computer components such as a processor, memory, disk drive, Compact Digital Read-Only Memory (CDROM), etc. (not shown). User input devices include keyboard 16 and mouse 18. Output devices include display 20 having a display screen 22. Naturally, many other configurations of a computer system are possible. Some computer systems may have other components in addition to those shown in FIG. 23A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 23A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 23A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention. A general-purpose processor, a DSP (Digital Signal Processor), an ASIC (Application Specific Integrated Circuit), an FPGA (Field Programmable Gate Array) or other like discrete gate or transistor logic, programmable devices, discrete hardware components, or any combination thereof might implement the illustrated logical blocks, circuits, engines described with reference to the illustrated embodiments. A general-purpose processor might include a microprocessor, controller, state machine or microcontroller. Note that a processor may be a combination of computing devices, a combination of a DSPs and ASICs, DSPs and a microprocessor, a plurality of microprocessors, one or more microprocessors in conjunction with a DSP core, or any other such configuration.

FIG. 23B also shows subsystems of the computer. In FIG. 23B, subsystems within box 40 are internal to, for example, the cabinet 12. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system, and some of the subsystems shown in FIG. 23B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible. In addition, method steps or algorithms described may be hardware, software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions or codes on a machine-readable medium and/or computer readable medium, which may be embodied in a computer program product. Further, in some aspects, a processor may embody the described functions and methods in one or more modules.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method comprising:
using a transmit mobile device having a processor and memory to generate lending data based in part on contact or calendar information structured to include a plurality of individually selectable fields which when selected are operable to lend data in the selected fields and when not selected, data in the non-selected fields are not lent or transmitted, the data lent by the individually selected fields being designated for storage at a receive mobile device for no more than a temporary duration;
communicating the lending data from the transmit mobile device to the receive mobile device, the receive mobile device storing, for a temporary duration, the lending data in a corresponding address book for use by said user; and
generating via the transmit mobile device, a signal to revoke the lending data upon expiration of the temporary duration or upon request by a user of said transmit mobile device.

2. The method of claim 1 further comprising
displaying, via the receive mobile device, data in each of the individually selected fields of the contact information.

3. The method of claim 1 further comprising
displaying, via the receive mobile device, each of the non-selected fields as blank information without data.

4. The method of claim 1 further comprising
setting, for the lending data, an expiration time, after which the lending data is deleted on the receive mobile device.

5. The method of claim 1 further comprising
setting, for the lending data, an indication to prevent a recipient from forwarding or adding data to the lending data after said lending data is received.

6. The method of claim 1 wherein the lending data comprises information for multiple contacts, wherein a single click or other user signal is used to lend the information for multiple contacts with the receive mobile device.

7. The method of claim 1 further comprising
creating, and communicating a transmit address book to lend information for multiple contacts with one or more recipients.

8. The method of claim 7 wherein the transmit address book is created by
selecting multiple contacts to share from an existing address book;
storing said multiple contacts in said transmit address book; and
selecting at least one individually selectable field operable to share the selected field for all of the multiple contacts in said transmit address book.

9. The method of claim 8 further comprising
selecting calendar information to share;
storing said calendar information in the transmit address book for sharing.

10. The method of claim 9 further comprising
selecting one or more recipients with whom said transmit address book is to be shared; and
storing said one or more recipients associated with one or more receive mobile devices in the transmit address book.

11. A method comprising
using a transmit mobile device having a processor and memory to generate lending data designated for temporary storage in a data store of a receive mobile device having a processor and said memory, said lending data based at least in part on contact or calendar data stored in an address book in said memory of said transmit mobile device;
transmitting said lending data operable for temporary storage in said data store of said receive mobile device; and
generating via the transmit mobile device, a signal to revoke the lending data upon expiration of a temporary duration or upon request by a user of said transmit mobile device.

12. The method of claim 11 wherein said lending data is based in part on contact or calendar information structured to include a plurality of individually selectable fields which when selected are operable to share data in the selected fields and when not selected, data in the non-selected fields are not shared, the data shared by the individually selected fields being designated for storage at said receive mobile device for no more than a temporary duration.

13. The method of claim 12 further comprising
displaying, via the receive mobile device, data in each of the individually selected fields of the contact information.

14. The method of claim 12 further comprising
displaying, via the receive mobile device, each of the non-selected fields as blank information without data.

15. The method of claim 11 further comprising
setting, for the lending data, an expiration time, after which the lending data is deleted on the receive mobile device.

16. The method of claim 11 further comprising
setting, for the lending data, an indication to prevent a recipient from forwarding or adding data to the lending data after said lending data is received.

17. The method of claim 11 wherein the lending data is communicated as a minimum of three-dimensional electronic business cards to the received mobile device.

18. The method of claim 11 further comprising
creating, and communicating a separate address book to share information for multiple contacts with one or more recipients.

19. The method of claim 18 wherein the separate address book is created by:
selecting multiple contacts to lend from an existing address book;
storing said multiple contacts in said separate address book;
selecting at least one individually selectable field operable to lend the selected field for all of the multiple contacts in said separate address book;
selecting calendar information to lend; and
storing said calendar information in the separate address book for lending.

20. The method of claim 19 further comprising
selecting one or more recipients with whom said separate address book is to be lent; and
storing said one or more recipients associated with one or more receive mobile devices in the separate address book.

21. A computer program product including a non-transitory computer readable storage medium having executable code, the code when executed by a processor is adapted for performing the following:
using a transmit mobile device having a processor and memory to generate lending data designated for temporary storage in a data store of a receive mobile device having a processor and said memory, said lending data based at least in part on contact or calendar data stored in an address book in said memory of said transmit mobile device;
transmitting said lending data operable for temporary storage in said data store of said receive mobile device; and
generating via the transmit mobile device, a signal to revoke the lending data upon expiration of a temporary duration or upon request by a user of said transmit mobile device.

22. The computer program product of claim 21 wherein said lending data is based in part on contact or calendar information structured to include a plurality of individually selectable fields which when selected are operable to lend data in the selected fields and when not selected, data in the non-selected fields are not lent, the data lent by the individually selected fields being designated for storage at said receive mobile device for no more than a temporary duration.

23. The computer program product of claim 21 further comprising
creating, and communicating a separate address book to lend information for multiple contacts with one or more recipients.

24. The computer program of claim 21 further comprising
setting, for the lending data, an expiration time, after which the lending data is deleted on the receive mobile device.
